(19) United States
(12) Patent Application Publication
(10) Pub. No.: US 2016/0219367 A1
(43) Pub. Date: Jul. 28, 2016

(54) PORTABLE WIRELESS WATERPROOF SPEAKERS WITH POWER MANAGEMENT

(71) Applicant: Grace Digital, Inc., San Diego, CA (US)

(72) Inventors: James Florczak, San Diego, CA (US); Greg William Fadul, San Diego, CA (US); James D. Palmer, JR., San Diego, CA (US)

(21) Appl. No.: 15/090,577

(22) Filed: Apr. 4, 2016

Related U.S. Application Data
(63) Continuation-in-part of application No. 14/045,748, filed on Oct. 3, 2013, now Pat. No. 9,307,307.

(51) Int. Cl. H04R 1/44; H04R 1/02; H04R 1/24; H04R 1/08

(52) U.S. Cl. CPC H04R 1/44; H04R 1/08; H04R 1/025; H04R 1/24; H04R 2420/07; H04R 2420/09; H04R 2430/01; H04R 2201/028

(57) ABSTRACT

A portable speaker system includes: a waterproof enclosure; a wireless communication element; a set of speakers; and a solar cell. A device able to provide multimedia content includes: a communication module able to be able to be communicatively coupled to a mobile device via a communication link; a processor able to receive multimedia data over the communication link; a set of output elements able to generate user-sensible outputs based at least partly on the received multimedia data; and an electromagnetic charging element. A multimedia playback device includes: a waterproof enclosure; a set of user interface (UI) features; a set of audio output elements; a set of audio input elements; at least one connection port; a wireless communication element; a rechargeable battery; and a light emitting diode (LED) flashlight output.

### CROSS-REFERENCE TO RELATED APPLICATIONS

This application is a continuation-in-part of U.S. patent application Ser. No. 14/045,748, filed on Oct. 3, 2013.

### BACKGROUND

Mobile devices such as smartphones, tablets, laptops, etc. are ubiquitous in society. Many users may “play” multimedia content (e.g., music, videos, etc.) using such mobile devices. In many cases, a user may want to play such content through an external element (e.g., an external set of speakers).

Existing solutions may force a user to physically connect a mobile device using one or more cables, thus limiting the freedom of the user to move the mobile device and/or use the mobile device for other functions (e.g., making and/or receiving phone calls).

In addition, existing solutions may not be able to withstand typical operating conditions to which some such elements may be subjected (e.g., water, dust, physical impacts, etc.).

Therefore, there exists a need for a set of speakers within a waterproof enclosure featuring shock resistance and wireless connectivity.

### SUMMARY

Some embodiments may provide a multimedia device that is able to provide various appropriate outputs (e.g., audio, video, etc.). The device may be housed in an enclosure that is waterproof, dustproof, shockproof, and/or otherwise protected from external environment conditions and/or forces.

The multimedia device may be able to connect to one or more mobile devices (e.g., a smartphone, PC, tablet, etc.) such that the multimedia device may receive data associated with multimedia content and generate outputs (e.g., audible sound, visible graphics, etc.) associated with the content. Some embodiments may receive, store, and provide multimedia content via an included storage element. The system may include radio receivers and/or tuners that allow reception of various broadcast signals.

Some embodiments may include lighted outputs such as flashlights, lanterns, flameless candles, etc. The system may include internal power generation or collection sources such as solar cells or kinetic energy collection elements. In addition, some embodiments may transmit or collect power via electromagnetic signals. The system may include a high-current power output.

The system may include two-way radio communication that allows for communication between and among multiple instances of the system. Some embodiments may provide voice recognition such that various commands may be implemented based on audible commands.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The exemplary features of the disclosure are set forth in the appended claims. However, for purpose of explanation, several embodiments are illustrated in the following drawings.

FIG. 1 illustrates several views of a playback element according to an exemplary embodiment;

FIG. 2 illustrates a schematic block diagram of a hardware system included with some embodiments of the playback element of FIG. 1;

FIG. 3 illustrates a schematic block diagram of a software system included with some embodiments the playback element of FIG. 1;

FIG. 4A illustrates an exploded top view of a waterproof case of some embodiments;

FIG. 4B illustrates a front view of the components of the waterproof case of FIG. 4A;

FIG. 5A illustrates an exploded top view of a front body section of some embodiments;

FIG. 5B illustrates a top view of the components of the front body section of FIG. 5A;

FIG. 6A illustrates a top view of a body section with a waterproof access element of some embodiments;

FIG. 6B illustrates a rear view of a body section with the waterproof access element of FIG. 6A;

FIG. 7A illustrates a top view of shock resistant features of some embodiments;

FIG. 7B illustrates a front view of shock resistant features of some embodiments;

FIG. 8 illustrates a bottom view of an enclosure with a mounting feature of some embodiments;

FIG. 9 illustrates a flow chart of a verification process performed in some embodiments;

FIG. 10A illustrates a flow chart of a process for establishing communications in some embodiments;

FIG. 10B illustrates a flow chart of a process for establishing radio communications in some embodiments;

FIG. 11 illustrates a flow chart of a process for receiving, playing, and controlling media in some embodiments;

FIG. 12 illustrates a flow chart of a process for implementing a speakerphone feature in some embodiments;

FIG. 13 illustrates a front-side perspective view of an exemplary portable speaker system of some embodiments;

FIG. 14 illustrates a top-rear perspective view of the portable speaker system of FIG. 13;

FIG. 15 illustrates a front elevation view of the portable speaker system of FIG. 13;

FIG. 16 illustrates a rear side elevation view of the portable speaker system of FIG. 13;

FIG. 17 illustrates a top plan view of the portable speaker system of FIG. 13;

FIG. 18 illustrates a bottom plan view of the portable speaker system of FIG. 13;

FIG. 19 illustrates a right elevation view of the portable speaker system of FIG. 13;

FIG. 20 illustrates a left elevation view of the portable speaker system of FIG. 13;

FIG. 21 illustrates a front-side perspective view of an exemplary portable speaker system of some embodiments;

FIG. 22 illustrates a top-rear perspective view of the portable speaker system of FIG. 21;

FIG. 23 illustrates a front elevation view of the portable speaker system of FIG. 21;

FIG. 24 illustrates a rear side elevation view of the portable speaker system of FIG. 21;

FIG. 25 illustrates a top plan view of the portable speaker system of FIG. 21;

FIG. 26 illustrates a bottom plan view of the portable speaker system of FIG. 21;

FIG. 27 illustrates a right elevation view of the portable speaker system of FIG. 21;

FIG. 28 illustrates a left elevation view of the portable speaker system of FIG. 21;

FIG. 29A illustrates a top plan view of an exemplary portable speaker system of some embodiments;

FIGS. 29B-29F illustrate various views of the portable speaker system of FIG. 29A;

FIGS. 30A-30E illustrate various views of an exemplary portable speaker system of some embodiments;

FIG. 31A illustrates a front elevation view of an exemplary portable speaker system of some embodiments;

FIGS. 31B-31C illustrate top and bottom plan views of the portable speaker system of FIG. 31A;

FIGS. 32A-32H illustrate various views of an exemplary portable speaker system of some embodiments; and

FIG. 33 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a portable waterproof speaker system.

Although various examples provided below may include audio content, one of ordinary skill will recognize that other types of multimedia content (e.g., video content, audio-visual content, graphics, etc.) may be provided by some embodiments. Similarly, although inputs such as microphones may be discussed in reference to specific examples, some embodiments may include other types of inputs (e.g., still and/or video cameras, motion and/or position sensing elements, etc.). Likewise, various examples may refer to speakers as outputs, but some embodiments may include other types of outputs (e.g., video displays, sensory outputs such as vibration, etc.).

In addition, although various examples below may describe “waterproof” properties of one or more elements, one of ordinary skill in the art will recognize that such elements may provide other associated properties (e.g., dustproof properties).

Several more detailed embodiments are described in the sections below. Section I provides a description of a system of some embodiments. Next, Section II describes various enclosure features of some embodiments. Section III then describes various methods of operation used by some embodiments. Next, Section IV describes exemplary implementations of some embodiments. Lastly, Section V describes a computer system which may be used with some embodiments.

### I. System

Sub-section I.A provides a description of various external features provided by some embodiments. Sub-section I.B then describes an exemplary hardware architecture of some embodiments. Lastly, sub-section I.C describes an exemplary software architecture of some embodiments.

A. External Features

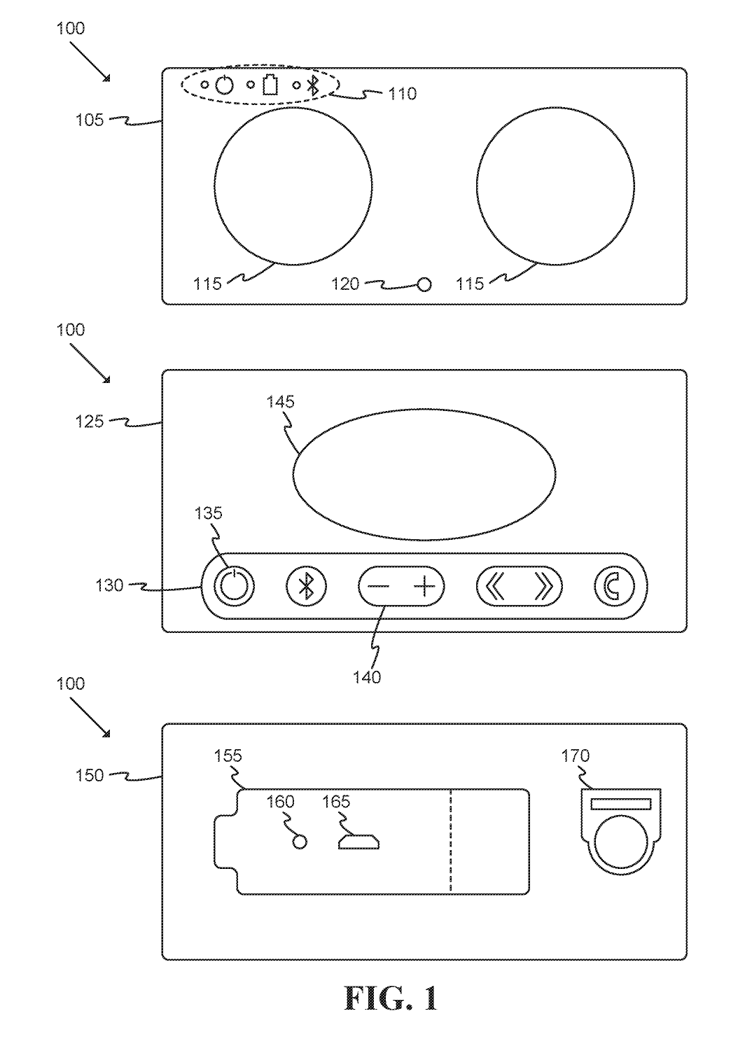

FIG. 1 illustrates a front view, top view, and rear view of an exemplary playback element 100 according to an exemplary embodiment. Specifically, this illustration shows various external features of the playback element.

As shown, the front face 105 may include various indicator elements 110, a set of speakers 115, and a microphone 120.

Each indicator element 110 may have an associated graphic indicator and lighted element (e.g., a visible LED). Each graphic indicator may provide a user with information regarding the purpose of the indicator element (e.g., device power, battery status, wireless connection status, etc.). Each lighted element may generate a visible output that provides an indication of the status of the playback element 100. Such visible outputs may include various specific implementations (e.g., a continuous light, a blinking light, etc.). In addition, each visible output may be able to generate different colors (or other appropriate differentiation) that may indicate the status of some element (e.g., a green light when a battery is charging, a red light to indicate the battery charge is low, etc.).

Each speaker 115 may include an exterior waterproof coating (or be composed at least partly using waterproof materials) and be coupled to an enclosure of the playback element 100 using waterproof adhesive and/or other appropriate ways. Similarly, the microphone 120 may include a waterproof coating or materials and may be coupled to the enclosure using waterproof adhesive. Different embodiments may include different arrangements of speakers and/or microphones (e.g., different numbers of components than shown, different orientations than shown, different sizes than shown, etc.).

As shown, the top panel 125 may include a recessed area 130 with a set of single-element controls 135 and a set of dual-element controls 140, and a passive woofer 145 (e.g., an oval port in the top panel with a waterproof membrane stretched across the port). The woofer, speakers 115, and/or microphone 120 may be protected by a water-permeable screen (e.g., a rigid metal panel with multiple holes that allow sound to pass through the screen and protects the components from external objects that may otherwise damage any fragile membranes associated with the various speakers, woofers, and/or microphones). The recessed area 130 may be sized such that the control elements 135-140 may not extend past the face of the top panel 125. In this way, control elements such as buttons may be less prone to be accidentally activated during use (or storage, transportation, etc.).

Each single-element control 135 may allow a user to control various functionality of the playback element 100 (e.g., power, activate wireless communication, activate speakerphone mode, etc.). In some embodiments, each single-element control 135 may control multiple functions (e.g., a wireless control button may be depressed and released to activate wireless communication, the same button may be held down for a period of time before being released to activate a “pairing” mode, etc.).

Each dual-element control 140 may control various appropriate functions that may be considered complementary (e.g., volume up/down, previous/next media element, etc.). Different embodiments may include different arrangements of control elements 135-140 (e.g., additional elements, fewer elements, elements arranged in different layouts, etc.).

As shown, the rear panel 150 may include a recessed area 155 with a set of connection ports 160-165 and an attachment element 170. The recessed area 155 may include a cover (not shown) that is able to provide a waterproof seal around the recessed area such that the connection ports 160-165 (and/or other appropriate elements) and not exposed to water, dust, etc. when the cover is secured.

In this example, a first connection port 160 may be able to receive an audio input (and/or provide an audio output). The first connection port 160 may allow a user to connect, for instance, a user device output (e.g., audio out, headphone out, etc.) to the playback element 100 in order to use the playback element to generate an audible output based at least partly on audio signals received through the connection port 160. The first connection port may allow a user to connect an element such as a musical instrument or microphone such that the sound may be amplified and delivered by the playback element 100. Different embodiments may have different specific connection ports having different sizes, shapes, etc., as appropriate.

The second connection port 165 may be able to allow a charging element or mobile device to be coupled to the playback element 100. For instance, in some embodiments the second connection port 165 may be a USB connector that is able to receive a power supply for charging an internal battery of the playback element 100 and/or to communicate with a mobile device (e.g., a smartphone, tablet, etc.) to receive media for playback, deliver audio data generated using the microphone, receive configuration data, etc.

The attachment element 170 of this example may include a receptacle for a strap (or other appropriate element) and be fastened to the enclosure in such a way (e.g., using a pivoting element) that the strap is able to be moved in various ways relative to the enclosure. In this way, a user may be able to attach a strap and/or clip to the playback element 100 such that the element may be attached to various things (e.g., a backpack, cooler, beach chair, etc.) for convenient use, transportation, and/or storage. Different embodiments may include different specific types, numbers, and/or configurations of attachment elements.

During operation, an internal battery of the playback element 100 may be charged by connecting a power source to a connection port (e.g., port 165). The playback element 100 may then be activated using a power button 135. A media source such as a smartphone may then be connected, either by connecting a cable from the source to a connection port (e.g., port 160) or establishing a wireless link (e.g., using a Bluetooth button 135). Such a wireless connection may allow the element 100 to maintain a waterproof state (e.g., by allowing any external flaps to be closed).

The media source may provide data across the link (e.g., audio data associated with an mp3 player application of a smartphone) which may be converted into an audio output and provided by the element 100 through the speakers 115, woofer 145, and/or connection port (e.g., port 160). Playback may then be controlled using the UI elements 135-140 and/or elements provided by the media source.

In addition, the element 100 may be used as a speakerphone element, for example by pressing a button 135 that causes media playback to cease and instead receives inputs through, for example, microphone 120 and converts and sends data associated with the inputs to a mobile device that, in turn, sends data that is received by the element 100 and provided to one or more appropriate outputs (e.g., speakers, audio output, etc.).

Although the playback element 100 has been described with reference to particular features and components, one of ordinary skill in the art will recognize that the playback element may be implemented in various different ways without departing from the scope of the disclosure. For instance, different embodiments may include different numbers, types, and/or arrangements of control elements such as buttons. As another example, different embodiments may include different arrangements of indication elements, speakers, connection ports, etc., than those shown.

B. Hardware Architecture

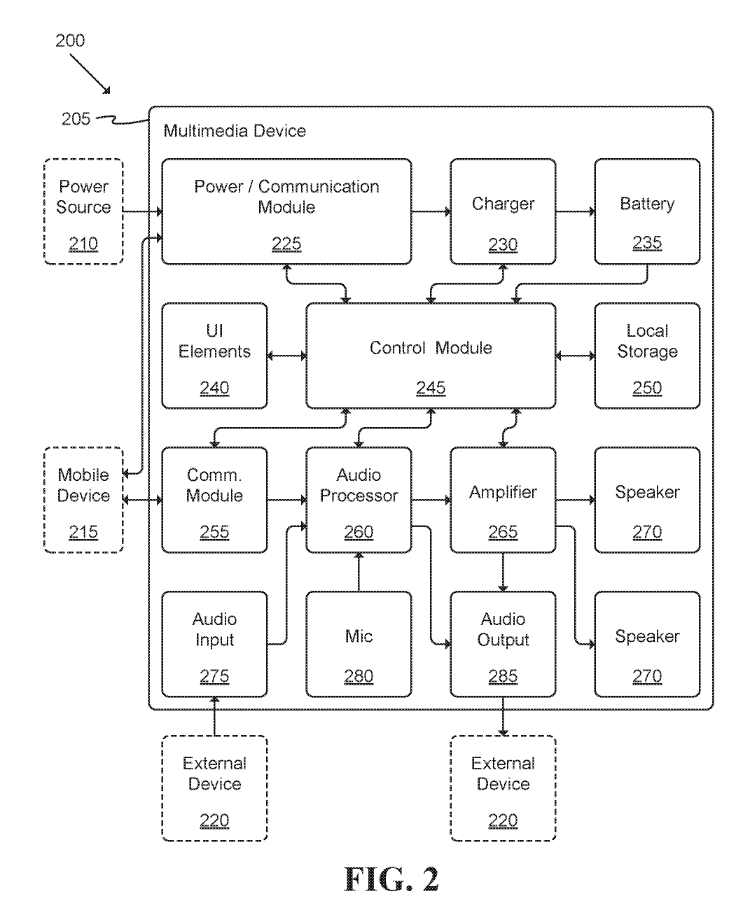

FIG. 2 illustrates a schematic block diagram of a hardware system 100 included with some embodiments of the playback element of FIG. 1. Specifically, FIG. 2 shows various components of the playback element and their interactions with external devices.

As shown, system 200 may include a multimedia device 205, a power source 210, a mobile device 215, and a set of external devices 220. The multimedia device 205 may be a device such as playback element 100 described above.

Power source 210 may be any source capable of providing power and connecting to the multimedia device (e.g., an AC power source, a USB connection to a powered device such as a PC, an external battery, a solar cell, etc.). In addition, the device 205 may include various embedded sources 210 such as a solar cell, hand crank or other kinetic energy source, etc.

The mobile device 215 may be any device that is capable of communicating with the multimedia device (e.g., a smartphone, tablet, mp3 player, DVD or blu-ray player, etc.). Such communication may be wired and/or wireless, as appropriate.

The external devices 220 may be external input sources (e.g., external microphones, instruments, mixers, etc.), external output sources (e.g., external speakers, recording devices, etc.), and/or an input/output source (e.g., a PC or mobile device, a headset with microphone, etc.).

Multimedia device 205 may include a power and/or communications module 225, a charger 230, a battery 235, a set of UI elements 240, a control module 245, local storage 250, a communication module 255, an audio processor 260, an amplifier 265, a set of speakers 270, a set of audio inputs 275, a microphone 280, and a set of audio output 285.

Power and/or communications module 225 may be provided via a physical port (e.g., a USB port or other appropriate cable connector). Such a module may be able to receive power and/or data through the physical port and communicate with other system elements. In addition, the module may be able to output power and/or data through the physical port. In some embodiments, the device 205 may be able to be operated using a power source provided through the module 225. The power and/or communications module of some embodiments may further include high-power output capability and control. Such an output may be used, for example, to jump-start a vehicle with a dead battery. In some embodiments, the module is able to send and/or receive power via electromagnetic energy to and/or from an external device (e.g., a smartphone, a charging station, etc.). Such an electromagnetic charger may include one or more coils and/or other associated elements used to transfer energy between devices.

Charger 230 may receive power from the power input 225 and provide charging power to the battery 235, as appropriate. In addition, some embodiments may allow the charger 230 to receive battery power and provide the power to an external device connected to the power input 225.

Rechargeable battery 235 may include one or more physical elements capable of receiving, storing, and/or providing power. Such elements may include, for instance, one or more lithium-ion elements, electrodes, casings, etc. Some embodiments may allow non-rechargeable and/or replaceable rechargeable batteries to be connected to the device (e.g., via a set of connectors, a waterproof battery cavity and associated waterproof cover, etc.). The device 205 may be operated using power stored by the battery 235 and provided to the various sub-elements of multimedia device 205 (e.g., via a power bus).

UI elements 240 may include various elements for receiving inputs from a user (e.g., buttons, switches, touchscreens, etc.) and various elements for providing outputs to a user (e.g., indicator LEDs, touchscreens, display elements, etc.). Such outputs may include lighting outputs, such as a flashlight-type output, lantern, flameless candle, etc. The lighting outputs may include various arrangements of one or more LEDs, lenses, mirrors, etc. In some embodiments, various UI elements may be provided by an external device. For instance, a smartphone may be used to provide control inputs to the multimedia device and/or display outputs from the device.

Control module 245 may interact with various other modules to control operations, communications pathways, etc. The control module may include various physical elements (e.g., switches, logic elements, programmable ICs, processors, etc.) and/or virtual elements (e.g., software modules, interfaces, etc.). The control module 245 may receive and evaluate inputs (e.g., inputs received via the UI elements 240) and generate appropriate outputs that are able to at least partially control functionality of the other modules of device 205.

Local storage 250 may be able to store data and/or instructions for use by the control module 245 (and/or other elements of multimedia device 205). Such data may include, for example, user preferences, default values, operating algorithms, media content, etc.

The communication module 255 may be able to communicate with various external elements (e.g., a mobile device such as a smartphone) using various appropriate pathways (e.g., a wired connection, a Bluetooth connection, a Wi-Fi connection, etc.). In some embodiments, the communication module may include a two-way radio that allows communication between and among devices 205. Alternatively, such devices may communicate across a local wireless link, cellular link, and/or other appropriate channels.

The communication module may be at least partially controlled using a UI element 240 (e.g., a button) and/or the control module 245 (which may include commands received from an external device).

The audio processor 260 may be able to receive inputs from the audio inputs 275, the communication module 255, the control module 245, the microphone 280 and/or other elements and generate an appropriate output signal to send to the amplifier 265, audio output 285, and/or other appropriate elements. The audio processor 260 may be able to send and/or receive analog and/or digital signals, as appropriate. In some embodiments, the audio processor may perform audio analysis to provide speech recognition.

The amplifier 265 may include various components capable of receiving an audio signal and generating an output that is able to drive one or more speakers 270. Such an amplifier 265 may also be able to generate an output that is able to drive one or more audio outputs 285. Each speaker 270 may be able to receive an audio signal and convert the signal to audible sound.

Each audio input 275 may include an input port or other appropriate connection and be able to receive inputs from an external device 220 and pass the input to the audio processor 260. Each microphone 280 may be able to capture audible sounds and generate an appropriate output to send to the audio processor 260. In some embodiments, the microphone 280 may automatically convert the received sounds to a set of digital signals. In some embodiments, the audio input 275 may include one or more radio receivers (and/or other appropriate receivers) that are able to receive broadcasts from various sources 220 (e.g., a radio station, two-way radio communication devices, other multimedia devices, etc.). The audio input 275 may further include various tuners that allow for selection from among available channels, frequencies, etc.

Each audio output 285 may include an output port or other appropriate connection and be able to generate outputs and pass the outputs to various external devices 220. Such outputs may be formatted in various appropriate ways, depending on the type of external device. In some embodiments, at least one audio input 275 and at least one audio output 285 may share a single connection port.

Different embodiments may include other different features, such as one or more video display elements (e.g., LCD panels, LED screens, touchscreens, etc.) and/or video input elements (e.g., a camera). In addition, some embodiments may include processing elements such as video and/or audio encoders and/or decoders. Such encoders and/or decoders may be implemented using different combinations of hardware, as appropriate.

During a typical operation scenario, a mobile device 215 may provide streaming audio content to the communication module 255 over a wireless channel (e.g., Bluetooth). The audio content may be delivered to the audio processor 260 which, in turn, provides an audio output to the amplifier 265 and the speakers 270. The content delivery (e.g., volume, type of content, etc.) may be controlled based on inputs received from UI elements 240 (and/or other appropriate elements) and interpreted by the control module 245.

In another typical operation scenario, a mobile device 215 may be coupled to the multimedia device 205 such that the multimedia device may be used as a speakerphone. The multimedia device may be able to receive inputs from the microphone 280, convert the inputs using the audio processor 260 and/or control module 245, and send the converted inputs to the mobile device 215. The mobile device may then send the received inputs to another party. The mobile device may further receive communications from the other party and relay the communications to the multimedia device 205 which may, in turn, process the received information using the communication module 255, audio processor 260, amplifier 265, and delivering the communications to a user through the speaker(s) 270.

If a power source 210 is connected, the device may be at least partially powered from the source and the battery 235 may be charged via the charger 230 and power input 225. Alternatively, if no power source 210 is connected, the device may operate on power provided by the battery 235.

One of ordinary skill in the art will recognize that the system 200 and multimedia device 205 are conceptual in nature and may be implemented in various different ways without departing from the scope of the disclosure. For instance, some embodiments may include different modules than those shown (e.g., additional modules, fewer modules, combined modules, divided modules, etc.). As another example, different embodiments may include various different communication pathways than shown. As still another example, different embodiments may include different numbers of inputs, outputs, ports, etc. than shown.

C. Software Architecture

Although various feature described below may be implemented as software features (e.g., sets of instructions executed by a processor), the various elements may instead be implemented as combinations of electronic circuitry (and/or other appropriate hardware elements, such as those described above in reference to FIG. 2) that together provide the various described features.

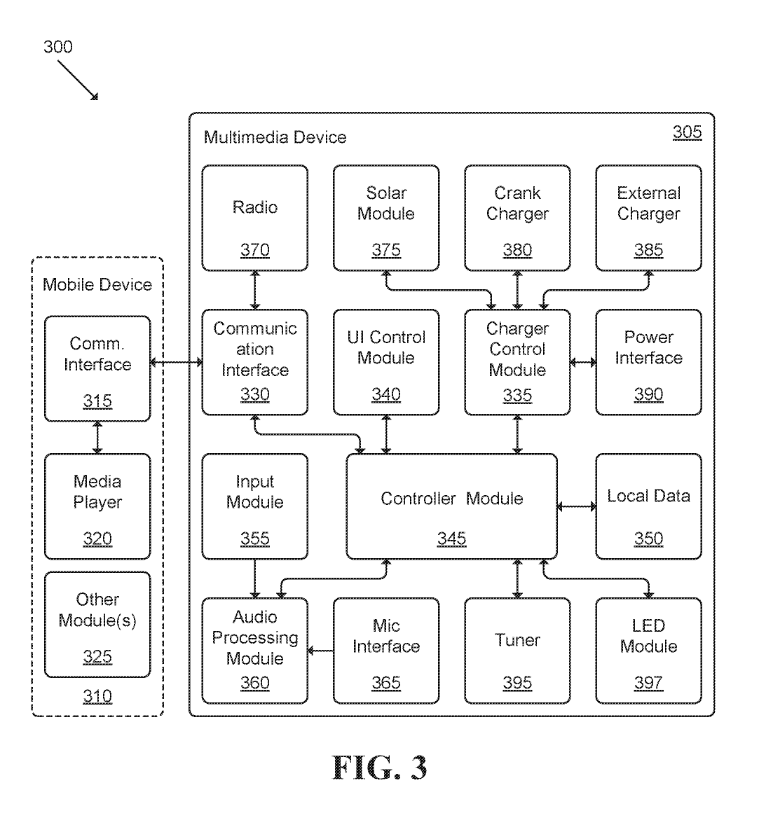

FIG. 3 illustrates a schematic block diagram of a software system 300 included with some embodiments the playback element 100. This figure highlights several components that may be included in some embodiments. Although described by reference to a software system 300, one of ordinary skill in the art will recognize that such a system may be implemented using various combinations of hardware and software elements. Some such systems may be implemented completely using hardware elements that do not execute software instructions.

As shown, the system 300 may include a multimedia device 305 (e.g., playback device 100, multimedia device 205 and/or other appropriate devices) and a mobile device 305 (e.g., mobile device 215). Some embodiments may include other elements (e.g., additional or other devices such as displays or storages, additional mobile devices, additional multimedia devices, etc.) that may also interact with the software system 300.

The mobile device 305 may include a communication interface 315, a media player 320, and/or other modules 325. The communication interface 315 may allow the mobile device 310 to communicate with the multimedia device 305 (e.g., via a cable connection, via a Bluetooth or other wireless connection, etc.). In some embodiments, the communication interface 315 may simply include a physical connection (e.g., a jack that allows for a cable to connect the devices).

The media player 320 may be able to access multimedia content (e.g., from a local storage of the mobile device 310, via a network connection, etc.) and generate output data associated with the media content. In addition, the media player 320 may be able to receive (e.g., via the communication interface 315, from a user interface of the mobile device 310, etc.) commands that may at least partially control operation of the media player 320 (e.g., pause, play, next, etc.).

The other modules 325 may be able to provide various other features. Such features may include, for instance, UI features, local storage access, remote storage access, and/or multimedia playback and/or display.

Multimedia device 305 may include a communication interface 330, a charger control module 335, a UI control module 340, a controller module 345, local data 350, an input module 355, an audio processing module 360, a microphone interface 365, a radio 370, a solar module 375, a crank charger 380, an external charger 385, a power interface 390, a tuner 395, and an LED control module 397.

The communication interface 330 may allow the various modules of the multimedia device 305 to communicate with the mobile device 310 and/or other multimedia devices 305 (e.g., via a cable connection, via a Bluetooth or other wireless connection, etc.). Some embodiments may include multiple communication interfaces 330, such that a first connection may be made with a first device, a second connection with a second device, etc. In addition, multiple types of communication interfaces 330 may be included in a single multimedia device 305 (e.g., a wired interface such as a USB connector, a wireless interface such as Bluetooth, etc.).

The charger control module 335 may manage the charging of a rechargeable battery included in some embodiments. The module may be able to receive power from various sources (e.g., a connection to an external source, an internal source such as a solar cell, etc.). The charger control module may be able to communicate with the controller module 345 and/or be able to determine a current battery charge level. In this way, the charger control module 335 may be able to control the amount of available power used to charge the battery. In some embodiments, the charger control module may be able to receive power from the internal battery and provide charging power to an external device (e.g., a mobile device such as a smartphone) via the external charger 385. The charger control module 335 may control and/or otherwise interact with various other modules, such as solar module 375, crank charger 380, external charger 385, and power interface 390.

The UI control module 340 may allow the multimedia device 305 to receive user inputs and provide outputs to the user. For instance, the UI control module 340 may receive signals associated with various physical buttons on the multimedia device 305. In addition, the UI control module 340 may provide various visual indications (e.g., using LEDs of various colors, using a touchscreen of a mobile device, etc.). Such a UI control module 340 may be able to receive data from various types and quantities of inputs and provide data to various types and quantities of outputs.

The controller module 345 may be able to communicate among the various other modules, execute various logical operations and/or instructions, and/or access local data 350. Local data may include data such as user settings, paired device information, media content, etc.

The input module 355 may include various interfaces and/or conversions that may allow the multimedia device 305 to receive inputs from external sources (e.g., audio devices, cameras, microphones, etc.).

The audio processing module 360 may include various elements that are able to receive signals from the input module(s) 355, microphone interfaces 365, and/or other appropriate elements and generate outputs that are able to be sent to an external device (e.g., mobile device 310) or otherwise used by the multimedia device 305 (e.g., for voice-control functionality related to the multimedia device UI).

In addition, the audio processing module 360 may be able to generate audio output signals that may be able to be provided via some output elements such as a set of speakers. Some embodiments may allow for selection from among a set of output options using the available elements (e.g., stereo, mono, left, right, surround, center, etc.). In some embodiments, multiple devices 305 may be able to be communicatively coupled such that the devices together provide a coherent set of audio outputs. For instance, a first device may be set to “left”, a second device set to “right”, and the two devices may together provide a stereo output. As another example, a third device may be set to “center” or “surround left” and used in conjunction with the left and right outputs.

The microphone interface 365 may include various elements that able to receive signals from a microphone and generate appropriate outputs for use by the audio processing module 360 and/or other appropriate modules.

Radio 370 may provide two-way communication with other multimedia devices 305 (and/or other radio-capable devices). Such a radio 370 may allow users to communicate locally via the multimedia devices 305 without requiring access (or use of) any network communication channels (e.g., a cellular network, wireless network, etc.).

Solar module 375 may interact with the charger control module 335 to allow solar charging and/or feedback. The solar module 375 may be associated with solar collection elements (e.g., solar panels) that are included in multimedia device 305 and/or external solar sources. The solar module 375 may be able to determine a relative strength of solar energy being absorbed and generate feedback (e.g., via a set of LEDs or other appropriate meter or UI element) that may allow a user to adjust the position of the device 305 to maximize the amount of solar energy collected.

Crank charger 380 may interact with a physical element such as a crank (and/or other kinetic energy collection elements) to allow charging via such a source. Such an element may allow the device 305 to be charged when other external sources are not available (e.g., at night when solar is not available, when a wall charger or socket is not available, etc.).

External charger 385 may allow power to be supplied from the battery of device 305 to an external device such as mobile device 310, another multimedia device 305, etc. The external charger 385 may be associated with various physical connections (e.g., a USB port), Some embodiments may provide wireless charging via an electromagnetic coil or other appropriate element. Such wireless charging may allow charging of a mobile device 310 or other appropriate element by placing the external device in physical contact (or within a close proximity) to the multimedia device 305, whereby the external charger 385 may generate or activate wireless charging of compatible external devices.

Power interface 390 may be able to receive stored energy from the battery of device 305 and generate an output with sufficient current flow to jump start a vehicle (e.g., an automobile, motorcycle, boat, etc.). In some embodiments, the power interface may be able to generate such an output using an alternative power source (e.g., an external batter or device).

Tuner 395 may be able to identify, receive, and/or decode various transmitted signals (e.g., AM radio, FM radio, in-band on-channel digital radio such as HD radio, emergency communication systems such as weather notification systems, etc.). The tuner may utilize various physical components that may be included with device 305. For instance, the tuner 395 may utilize one or more device antennas, receivers that may be associated with one or more communication spectrums, etc.

In addition, the tuner may provide various UI information and/or receive various commands or other communications. For instance, the tuner may provide a list of channels or frequencies that are available. Such a list may be presented to a user in various ways (e.g., via a display, as a set of scroll options, etc.). User selections may then be received in various appropriate ways depending on the UI elements used or available. For instance, on a device with a limited number of buttons, a set of up/down or next/previous buttons may be utilized to scroll through a list of channels (or scan to identify the next available channel, transmission frequency, etc.). As another example, a device with a touchscreen display may allow a user to directly select from a set of options (e.g., via a set of touchscreen buttons), with the selection sent to the tuner (e.g., as a specified frequency, channel, identifier, etc.).

LED control module 397 may be able to control one or more output LEDs. Such LEDs may be utilized to provide functionality such as a flashlight, lantern, flameless candle, etc.

During operation, a communication link may be established between the mobile device 310 and multimedia device 305 through the communication interfaces 315 and 330. Media content may be provided form the media player 320 and/or other modules 325 and sent to the multimedia device over the link. Alternatively, media content may be retrieved from local data 350.

The media content data received by the multimedia device 305 may be passed through the controller 345 to the audio processing module 360 and output by the device (e.g., using a set of speakers associated with the audio processing module).

The UI control module 340 may continuously determine whether any inputs have been received. Such received inputs may be passed to the controller 345 which may, in turn, perform a set of operations based on the received inputs. For instance, an input such as a button press may be associated with increasing volume through the audio processing module 360. Pressing a different button may cause the multimedia device 305 to enter a speakerphone mode when connected to an appropriate mobile device 310 (e.g., a smartphone or other cellular communication device). In addition, the UI control module 340 may receive inputs that are passed through the controller 345 and interface 330 to the mobile device 310, where the data received by the mobile device may cause the mobile device to perform various appropriate operations (e.g., at least partially controlling the operation of the media player 320, causing the device 310 to end a call, etc.).

During speakerphone operation, the multimedia device 305 may act as an external microphone and speakers for the mobile device 310. Audio inputs may be received through the microphone interface 365, processed, and passed to the mobile device 310 over the link, such that the mobile device may transmit the received audio to another party to the call. Likewise, audio that would normally be provided through an internal speaker or headset of the mobile device may instead be passed to the multimedia device 305 over the link, processed, and output through a set of speakers included in the multimedia device. The device 305 may be used in a similar way to provide two-way radio communication.

One of ordinary skill in the art will recognize that the system 300 and multimedia device 305 are conceptual in nature and may be implemented in various different ways without departing from the scope of the disclosure. For instance, some embodiments may include different modules than those shown (e.g., additional modules, fewer modules, combined modules, divided modules, etc.). As another example, different embodiments may include various different communication pathways than shown. As still another example, different embodiments may include different numbers of interfaces, inputs, outputs, etc. than shown.

### II. Enclosure

Sub-section II.A provides a description of various waterproof features of some embodiments. Sub-section II.B then describes shock-resistant features of some embodiments. Next, sub-section II.C describes mounting features of some embodiments. Lastly, sub-section II.D describes verification testing performed on some embodiments.

A. Waterproof Features

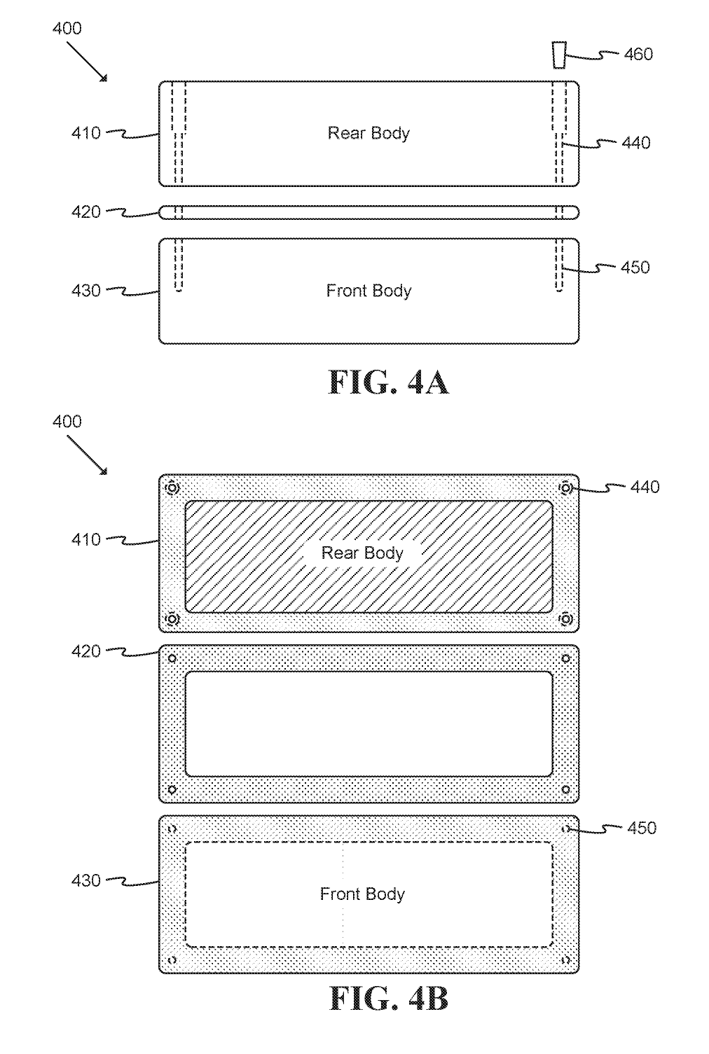

FIG. 4A illustrates an exploded top view of a waterproof case 400 of some embodiments. FIG. 4B illustrates a front view of the components of the waterproof case 400. Specifically, these figures highlight various components that may be used to create a waterproof enclosure. As shown, the case may include a rear body portion 410, a gasket 420, a front body portion 430, a set of fastener channels 440, a set of fastener receptacles 450, and a set of stoppers 460.

The rear body portion 410 may be constructed of appropriate combinations of materials (e.g., plastic, rubber, metal, etc.) and may include the set of fastener channels 440. Each fastener channel may allow a fastener such as a screw to pass through the channel. The channel may be of varying diameters, as shown, such that a screw head may be restrained at a point along the channel, while the body of the screw may be able to pass the point.

The front body portion 430 may be constructed of appropriate combinations of materials (e.g., plastic, rubber, metal, etc.) and may include the fastener receptacles 450. Each fastener receptacle may be sized and/or shaped such that a fastener such as a screw is able to pass through at least a portion of the first fastener channel 440 and be secured into at least a portion of the receptacle 450 such that the front body portion 430 and rear body portion 410 are drawn together (along contacting regions of the portions, as shown in FIG. 4B), compressing the gasket 420 between the body portions 410 and 430.

The connection features formed by the fastener channels 440 and the receptacles 450 may be spaced in various appropriate ways around the contacting regions of the body portions 410 and 430. Different embodiments may include different numbers, sizes, shapes, etc. of connection features, as appropriate.

Gasket 420 may be made of various appropriate materials (e.g., rubber, silicon, etc.) and may be pre-formed such that a complete gasket is aligned between the body portions prior to connecting the portions or may be applied to one or more body portions along the contacting regions (e.g., as a waterproof adhesive).

Stopper 460 may be sized such that the stopper may be inserted into at least a portion of the fastener channel 440 such that a waterproof seal is formed. Such a stopper 460 may be made of various appropriate materials (e.g., rubber, silicon, etc.) and may be shaped appropriately (and/or compressed prior to placement) such that the stopper may form a seal with the wall of the channel 440 (e.g., by having a tapered shape).

During assembly (after placing any internal components such as electronics and/or external components such as UI elements), the body sections 410 and 430 may be aligned and the gasket 420 may be aligned or applied, as appropriate. The various fasteners may be used to attach the front and rear sections 410 and 430 such that sufficient force is applied to generate a waterproof seal in conjunction with the gasket 420. The outer opening of the first channels 440 may then be sealed by placing a stopper 460 at least partially inside each channel such that a waterproof seal is formed along an outer edge of the stopper and an outer edge of the opening of the channel 440.

One of ordinary skill in the art will recognize that the case (or housing) of FIGS. 4A-4B is conceptual in nature and may be implemented in various specific ways without departing from the scope of the disclosure. For instance, although the front and rear body sections are shown as being approximately the same size, different embodiments may size the portions in various ways (e.g., a rear body section may form the majority of the enclosure while the front body section may be a thin faceplate). In addition, the housing may include multiple layers (e.g., a structural inner layer made of metal and/or plastic, an outer layer made of rubber of an appropriate thickness to provide waterproof and shock-absorbent features of some embodiments, etc.).

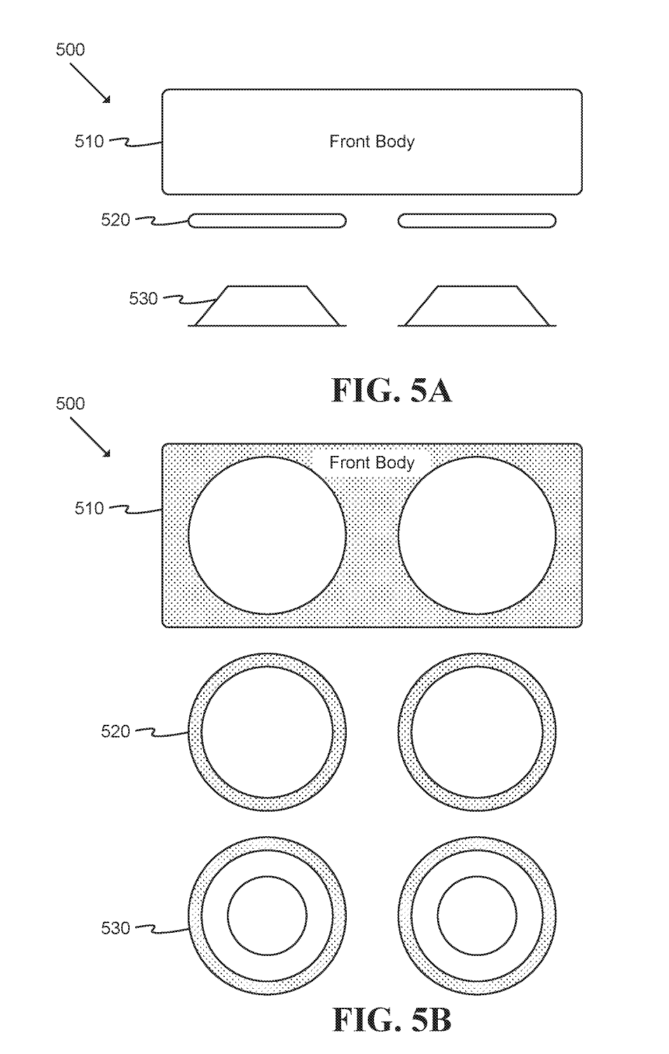

FIG. 5A illustrates an exploded top view of a front body section 500 of some embodiments. FIG. 5B illustrates a top view of the components of the front body section 500. Specifically, these figures highlight various components that may be used to create a waterproof enclosure. As shown, the front section may include an enclosure 510, a set of gaskets 520, and a set of speakers 530. In addition, such a front section may include a set of microphones and appropriate sealing features (not shown) and/or other waterproof elements such as LED outputs, buttons or controls, etc. (not shown).

Each speaker 530 may be attached to the enclosure 510 through an appropriately-sized port using a gasket 520. In some embodiments, each gasket may be applied to portions of the body 510 and/or speaker 530 as a waterproof adhesive layer (e.g., a liquid, gel, paste, tape, and/or other appropriate form of adhesive) at the time of assembly. Alternatively, each gasket 520 may be pre-formed element (e.g., a rubber gasket). Each speaker 530 may include a waterproof damper (e.g., a damper coated with rubber of an appropriate thickness such as 0.18 mm).

Any other elements of the front section 500 may be attached and/or sealed as appropriate. For instance, a set of UI elements may be attached to a printed circuit board (PCB) and/or other appropriate element that is then attached to the front section. Such UI elements (e.g., buttons, lights, etc.) may then be externally sealed, as appropriate (e.g., buttons may be covered by a layer of rubber, LEDs may be adhered to the enclosure using waterproof adhesives, etc.).

One of ordinary skill in the art will recognize that the case (or housing) of FIGS. 5A-5B is conceptual in nature and may be implemented in various specific ways without departing from the scope of the disclosure. For instance, different embodiments may include various different elements than shown. As another example, different embodiments may be shaped and/or sized in various different ways. As still another example, different embodiments may attach components in various different ways (e.g., speakers may be attached to an external surface of a front face of the enclosure and/or to an internal surface of the front face of the enclosure).

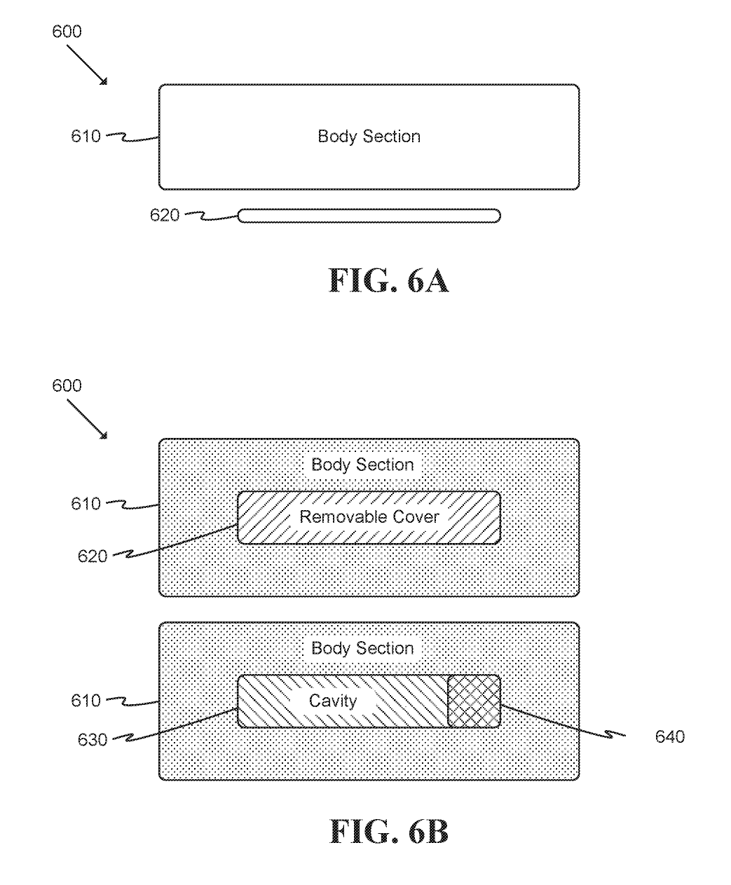

FIG. 6A illustrates a top view of a body section 600 with a waterproof access element of some embodiments. FIG. 6B illustrates a rear view of the body section 600. Specifically, these figures highlight various components that may be used to create a waterproof enclosure. As shown, the rear section 600 may include an enclosure 610 and a removable (or partly-removable) access cover 620.

The removable cover of some embodiments may be made of flexible, waterproof materials (e.g., rubber, silicon, etc.), and may include an attachment feature (e.g., an extending prong, a flap, etc.) that may be able to be attached to the enclosure 610 in such a way (e.g., using adhesive, using compression elements, etc.) that a waterproof seal is formed when the removable cover 620 is in a “closed” position. In some embodiments, the entire cover may be removed from the enclosure when in an “open” position. Alternatively, only a portion of the cover may be removed while a portion (e.g., the attachment feature) remains attached to the enclosure. The removable cover may be associated with a cavity 630 and attachment region 640.

The cavity 630 may defined an area that has waterproof protection when the removable cover 620 is in a closed position and that is accessible when the removable cover 620 is in an open position. The cavity may include various connectors (e.g., USB ports, microphone/headphone connectors, etc.) that may be used to couple a multimedia device of some embodiments to various external elements (e.g., a mobile device, a charging source, etc.).

In some embodiments, the cavity 630 may include a double-wall design (not shown) such that a portion of the cover 620 extends between the walls to form a seal around the cavity.

The attachment region 640 may include an area to apply adhesive, a receptacle, compression fitting or other appropriate attachment element, and/or other appropriate features that may allow at least a portion of the removable cover 620 to be attached to the enclosure 610. Any remaining portion of the cover 620 may then be free to engage with the cavity 630 to form a waterproof seal, or disengage to allow access to the cavity 630.

During operation, the removable cover 620 may be kept in a closed position to achieve a waterproof enclosure. If a user desires to connect the multimedia device using a physical connection such as a cable (e.g., to a mobile device, to a charging source, etc.), the user may pull a tab (not shown) of the cover to release a portion of the cover from the cavity 630. After disconnecting the device the user may close the cover 620 by pressing the portion of the cover into the cavity 630.

One of ordinary skill in the art will recognize that the case (or housing) of FIGS. 6A-6B is conceptual in nature and may be implemented in various specific ways without departing from the scope of the disclosure. For instance, the access cover of some embodiments may be shaped or sized in various different ways. As another example, the access cover may be attached to the enclosure in various appropriate ways (e.g., adhesive, fasteners, etc.) and/or formed integrally with the enclosure.

For instance, in some embodiments, the enclosure may include an additional waterproof compartment that is able to house a mobile device (e.g., a device that is providing streaming content, a device being charged, etc.). Such a compartment may include a waterproof cavity within the enclosure and have an associated waterproof cover. In some embodiments, the cover may be transparent or semi-transparent such that a display associated with the mobile device may be accessed. In addition, some embodiments may include pliable covers that allow use of a touchscreen associated with the mobile device.

B. Shock Resistant Features

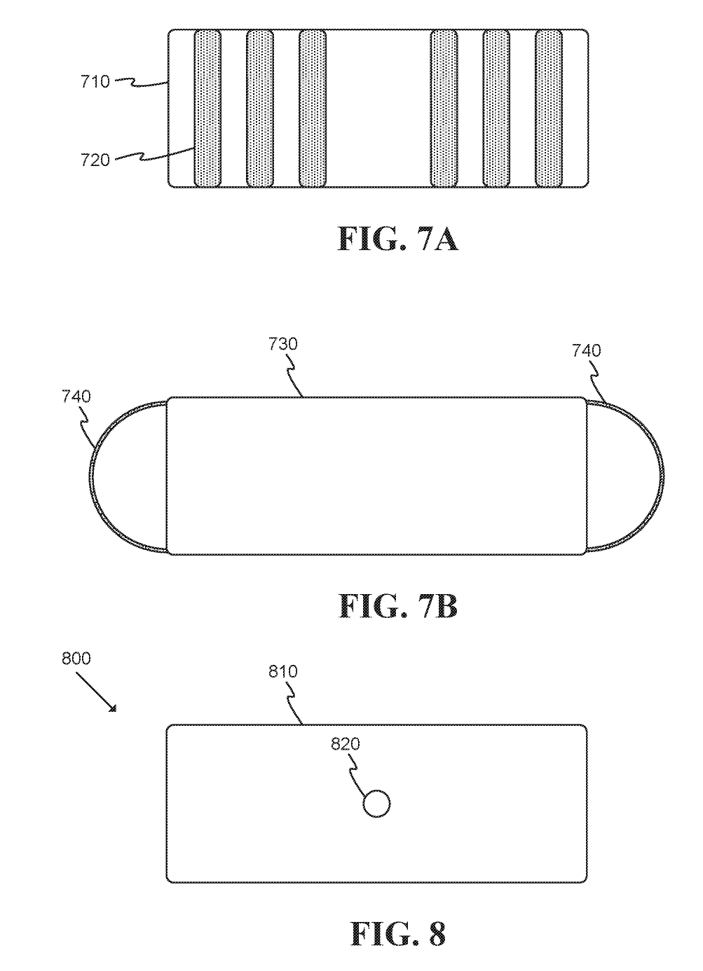

FIG. 7A illustrates a top view of an enclosure 710 with shock resistant features 720 of some embodiments. Specifically, this figure shows various external “ribs” 720 that may be spaced along an exterior surface of the enclosure to provide shock resistance. Such ribs may be formed by including various protuberances (e.g., sections of thick rubber ribs) along the exterior of the enclosure 710.

FIG. 7B illustrates a front view of an enclosure 730 with shock resistant features 740 of some embodiments. Specifically, this figures shows rounded handles 740 that may be utilized to grasp, hold, and/or transport the enclosure 730. In addition, such handles may provide shock absorbing properties (e.g., by sizing the handles with an appropriate thickness such that the handles are able to flex and absorb impact forces applied to the handles).

In some embodiments, the housing may include a polycarbonate (PC) inner shell with thermoplastic elastomer (TPE) covering an exterior surface of the housing. The inner shell may have a minimum thickness (e.g., 1.9 mm, 2.2 mm, etc.). In addition, the TPE covering may have a minimum thickness (e.g., 2.0 mm).

Some embodiments may include speaker mounts (not shown) that are specifically able to be fastened to the inside of the device front panel to support the weight of the speaker magnets during a shock event.

One of ordinary skill in the art will recognize that the shock absorbing features of FIGS. 7A-7B are exemplary in nature and may be implemented in various specific ways without departing from the scope of the disclosure. For instance, although some embodiments may include ribs and handles. As another example, different embodiments may include different numbers, sizes, shapes, etc. of handles and/or ribs.

C. Mounting Features

FIG. 8 illustrates a bottom view of an enclosure 810 with a mounting feature 820 of some embodiments. In this example, the mounting feature may be a flat-bottomed screw hole (e.g., for attaching to a standard tripod mount) or other appropriate mounting feature that may allow the enclosure 810 to be securely fastened to an external element such as a floor stand, wall mount, etc.

One of ordinary skill in the art will recognize that different embodiments may include various different types, numbers, sizes, and/or other variations of mounting features, as appropriate (e.g., screw-on fittings, compression fittings, etc.). In addition, the mounting (or fastening) features may be place at various appropriate locations along the exterior surface of the enclosure of some embodiments.

D. Verification Testing

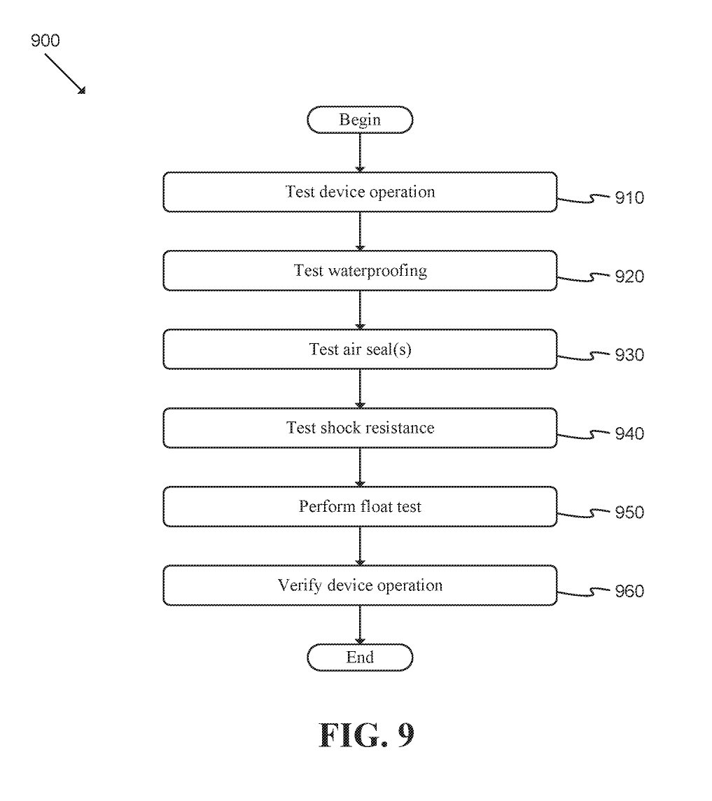

FIG. 9 illustrates a flow chart of a verification process 900 performed in some embodiments. Such a process may be performed, for instance, after a multimedia device (e.g., device 100) has been assembled. In some embodiments, the verification may be performed using a completely assembled unit. In other embodiments, elements and/or sets of elements may be tested whether assembled into a complete unit or not. In some embodiments, each completely assembled unit may be testing using a process such as process 900.

As shown, the process may test (at 910) device operation. Such testing may involve subjecting the device to various set of inputs (e.g., audio inputs, control inputs, etc.), measuring various sets of outputs (e.g., audio outputs, response to control inputs, etc.), and comparing the measured values to a set of test criteria (e.g., lower and upper thresholds for various parameters).

Next, the process may test (at 920) waterproofing. Such testing may include subjecting the device under test (DUT) to various conditions (e.g., being placed one meter underwater for thirty minutes, being placed 0.3 meters underwater for twelve hours, etc.). Such conditions may be specified by various appropriate bodies. Each DUT may include various sets of components included in some embodiments, and may include all elements in a completely assembled device.

The process may then test (at 930) air seals of the enclosure. Such testing may include applying pressure (e.g., ten kilopascals) for a set of durations (e.g., thirty seconds each) while the enclosure is connected to an air pressure measuring element that is able to identify any air leaks in each section of the enclosure. For instance, each body section may be aligned with a test jig that includes an appropriately sized receptacle for the section under test (and/or appropriate gaskets, etc.).

Process 900 may then test (at 940) shock resistance of the enclosure (and/or portions of the enclosure). For instance the DUT may be dropped from a particular height a specified number of times, compressed under a load, etc.

Next, the process may perform (at 950) a float test. Such a test may involve placing the DUT in (at least to a specified depth, such as three-tenths of a meter or one meter) and/or on a body of water and determining whether at least a portion of the DUT remains positioned above the water line when the DUT is released.

Lastly, the process may verify (at 960) operation of the DUT and then may end. Such verification may include various input/output tests (e.g., a data stream may be provided to an input of the device and the resulting output may be measured and compared to various appropriate operational limits).

Depending on the results of the verification performed at 960, each DUT may be deemed acceptable or not acceptable. DUTs that are deemed not acceptable may be excluded from consumer use.

One of ordinary skill in the art will recognize that although process 900 has been described by reference to various details, different embodiments may implement the process in various different ways without departing from the scope of the disclosure. For instance, different embodiments may perform the operations in different orders. As another example, various operations may be omitted and/or various other operations may be included. The process may be broken into a set of sub-process and/or be included as a sub-process of a larger macro-process.

### III. Methods of Operation

Sub-section III.A describes establishing a communication link among system elements of some embodiments. Sub-section III.B then provides a description of media playback and control of some embodiments. Lastly, sub-section III.C describes an exemplary process used to provide a speakerphone in some embodiments.

A. Communications

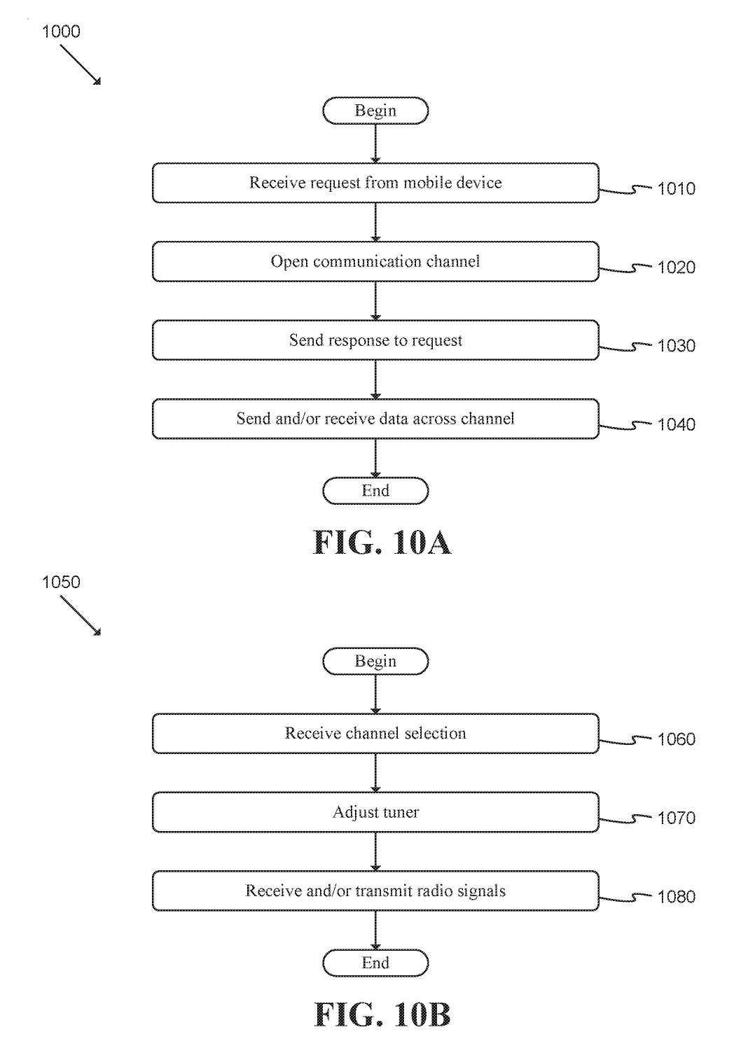

FIG. 10 illustrates a flow chart of a process 1000 for establishing communications in some embodiments. Such a process may be performed by a device such as multimedia device 205 described above, and may specifically use a module such as communication interface 330 described above (and/or other appropriate modules).

The process may begin, for instance, when a user powers on and/or activates a communication link of the multimedia device (e.g., by pressing a button to turn on a Bluetooth element). Next, the process may receive (at 1010) a request from a mobile device (e.g., mobile device 215 described above). Alternatively, the process may provide a signal to the mobile device indicating that the multimedia device is available for pairing.

Next, the process may open (at 1020) a communication channel and send (at 1030) a response to the request from the mobile device. Different embodiments may perform various different specific operations to open the channel (e.g., transferring a set of messages among the devices to be connected, assigning various parameter values, etc.). Such a communication channel may use various protocols, interfaces, and/or other elements, as appropriate.

Process 1000 may then send and/or receive (at 1040) data across the channel and then end. Such data may include, for instance, multimedia data provided by the mobile device to the multimedia device. The data may include, as another example, audio data associated with a phone call being provided by the mobile device to the multimedia device, while the multimedia device may receive audio inputs through a microphone and send audio data associated with the phone call from the multimedia device to the mobile device.

A similar process may be used to communicatively couple multiple multimedia devices of some embodiments.

FIG. 10B illustrates a flow chart of a process 1050 for establishing radio communications in some embodiments. Such a process may be performed by a device such as multimedia device 205 described above, and may specifically use modules such as communication interface 330 and radio module 370 described above (and/or other appropriate modules).

As shown, the process may receive (at 1060) a channel selection. Such a selection may be made in various appropriate ways (e.g., as a selection from a list, as a specified frequency, as a command to scan for the next available signal, etc.). The process may then adjust (at 1070) the tuner (e.g., tuner 395) in order to receive the selected channel. Next, the process may receive and/or transmit (at 1080) radio signals depending on the type of usage (e.g., receiving broadcast radio versus communicating over a two-way channel).

One of ordinary skill in the art will recognize that although processes 1000 and 1050 have been described by reference to various details, different embodiments may implement the processes in various different ways without departing from the scope of the disclosure. For instance, different embodiments may perform the operations in different orders. As another example, various operations may be omitted and/or various other operations may be included. Each process may be executed continuously, at regular intervals, based on some criteria, and/or at other appropriate times. Each process may be broken into a set of sub-process and/or be included as a sub-process of a larger macro-process.

B. Media Playback and Control

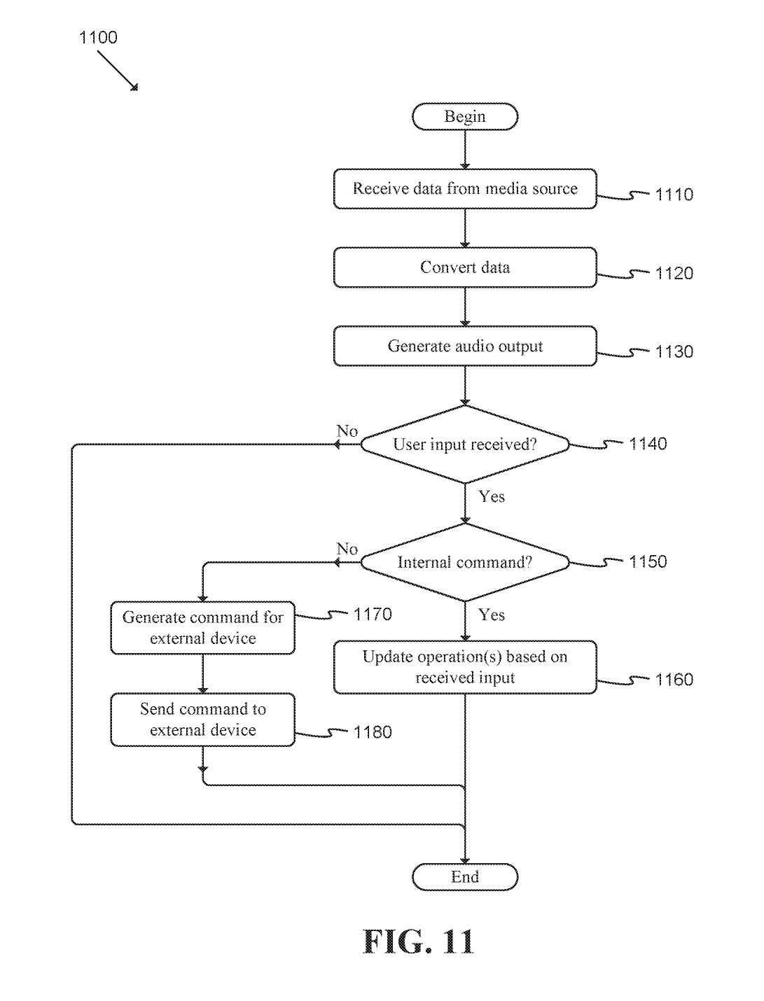

FIG. 11 illustrates a flow chart of a process 1100 for receiving, playing, and controlling media in some embodiments. Such a process may be performed by a device such as multimedia device 205 described above. The process may begin, for instance, after a communication channel or link has been established (e.g., using process 1000 described above) and a media source (e.g., a device such as mobile device 215 described above) begins providing data over the link.

As shown, the process may receive (at 1110) data from the media source. Such data may be associated with various types of multimedia and/or other data (e.g., audio data, video data, control commands, etc.). Alternatively, the data may be retrieved from a local storage (e.g., local data 350) or via a broadcast signal (e.g., AM, FM, etc.).

Next, the process may convert (at 1120) the received data. Such conversion may include, for instance, generating an analog audio signal output based at least partly on a received bit stream. As another example, conversion may involve decoding a command into a format that may be used to at least partially control the operation of the multimedia device.

The process may then generate (at 1130) an audio output (and/or other types of multimedia outputs). The audio output may be generated, for instance, by providing an audio signal to an audio processor that may perform various operations (e.g., equalization, compression, etc.) to the signal and then send the signal to an audio amplifier such that the audio may be output through a set of speakers (or other appropriate element). Similarly, other types of outputs (e.g., video) may be processed and output through an appropriate element (e.g., a display screen). For instance, an LCD video display screen may be used to present caller ID information, song metadata, video content, etc.

Next, the process may determine (at 1140) whether any user input has been received. Such an input may be received through one or more UI elements of the multimedia device, as described above. If the process determines (at 1140) that no user input has been received, the process may end.

In some embodiments, the user inputs may include voice commands. For instance, the audio processing module 360 of some embodiments may identify spoken audio received through a microphone of the multimedia device (or other appropriate device), analyze the received audio to identify spoken commands (e.g., “play”, “stop”, “next”, etc.) and relay the commands for implementation.

If the process determines (at 1140) that a user input has been received, the process may then determine (at 1150) whether the input is associated with an “internal” command. Such an internal command may be any command that directly controls the operation of the multimedia device (e.g., volume, activate wireless channel, etc.). If the process determines (at 1150) that the input is associated with an internal command, the process may update (at 1160) the operation of the multimedia element based at least partly on the received input (e.g., by raising or lowering the volume, by activating wireless communication circuitry, etc.) and then may end.

If the process determines (at 1150) that the command is not internal (i.e., that the command is related to operations of a connected device), the process may generate (at 1170) a command for the external connected device, send (at 1180) the command to the external device and then may end. Such “external” commands may include, for instance, next, previous, etc. and may allow a user to at least partially control multimedia data that is sent to the multimedia device (e.g., by skipping a song in a playlist, by replaying a song, etc.). The external device command may be generated in various appropriate ways and may be formatted appropriate for the device receiving the command. Some embodiments may send such a command over a wireless communication link (e.g., Bluetooth).

Some embodiments may iteratively perform operations 1110-1180 as long as a connection exists between the multimedia device and the mobile device. In some embodiments, various operations may be performed in parallel (e.g., media data may continuously be received and output while also continuously monitoring for user inputs).

One of ordinary skill in the art will recognize that although process 1100 has been described by reference to various details, different embodiments may implement the process in various different ways without departing from the scope of the disclosure. For instance, different embodiments may perform the operations in different orders. As another example, various operations may be omitted and/or various other operations may be included. The process may be executed continuously, at regular intervals, based on some criteria, and/or at other appropriate times. The process may be broken into a set of sub-process and/or be included as a sub-process of a larger macro-process.

C. Speakerphone

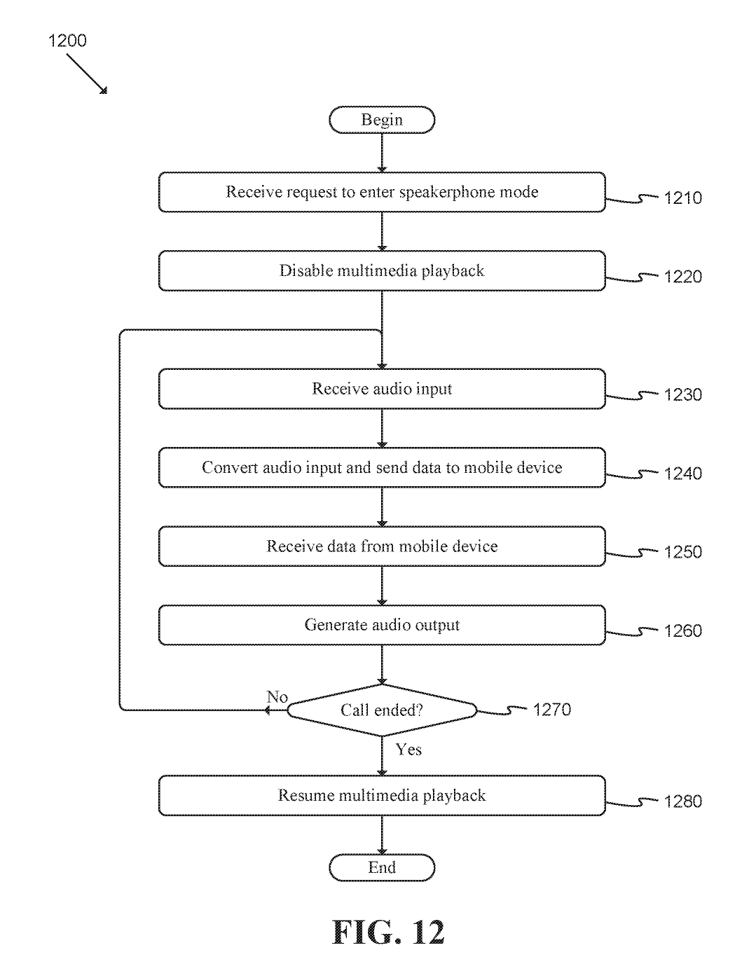

FIG. 12 illustrates a flow chart of a process 1200 for implementing a speakerphone feature in some embodiments. Such a process may be performed by a device such as multimedia device 205 described above. The process may begin, for instance, after a communication channel or link has been established (e.g., using process 1000 described above).

As shown, process 1200 may receive (at 1210) a request to enter speakerphone mode. Such a request may be received in various appropriate ways (e.g., a user may press a button associated with the speakerphone function). Next, the process may disable (at 1220) multimedia playback (e.g., if the multimedia device is currently producing audio related to a media stream, the audio output may be disabled and/or a request to pause or stop the stream may be send to a connected device).

The process may then receive (at 1230) audio inputs (e.g., through a microphone of the multimedia device). Next, the process may convert (at 1240) the received input and send the resulting data to the connected mobile device. Such conversion may include analog to digital conversion, signal processing, and/or other appropriate operations. The data may be sent over a wireless communication link (e.g., Bluetooth).

Next, the process may receive (at 1250) data from the connected mobile device. Such data may include, for instance, audio data associated with the phone call. The process may then generate (at 1260) an audio output (e.g., by processing the received audio data and providing audio through a set of speakers) based at least partly on the data received from the mobile device.

Process 1200 may then determine (at 1270) whether the call has ended. Such a determination may be made in various appropriate ways (e.g., based on a message and/or command received from the mobile device, based on a user input received at the multimedia device, etc.). If the process determines (at 1270) that the process has not ended, the process may iteratively perform operations 1220-1270 until the process determines (at 1270) that the call has ended.

If the process determines (at 1270) that the call has ended, the process may automatically resume (at 1280) multimedia playback (if appropriate) and then end. Alternatively, if no media had been streaming prior to the call, the process may end after determining (at 1270) that the call has ended.

A similar process may be used to provide two-way radio communication between the multimedia device and other radio devices (e.g., other multimedia devices). Audio data may be received at each device and transmitted to the other where it is received and provided. Such a scenario may utilize various UI elements to allow the users to control whether the device is transmitting or receiving (e.g., a button may be used that provides functionality similar to a walkie-talkie button).

One of ordinary skill in the art will recognize that although process 1200 has been described by reference to various details, different embodiments may implement the process in various different ways without departing from the scope of the disclosure. For instance, different embodiments may perform the operations in different orders. As another example, various operations may be omitted and/or various other operations may be included. The process may be executed continuously, at regular intervals, based on some criteria, and/or at other appropriate times. The process may be broken into a set of sub-process and/or be included as a sub-process of a larger macro-process.

### IV. Exemplary Implementations

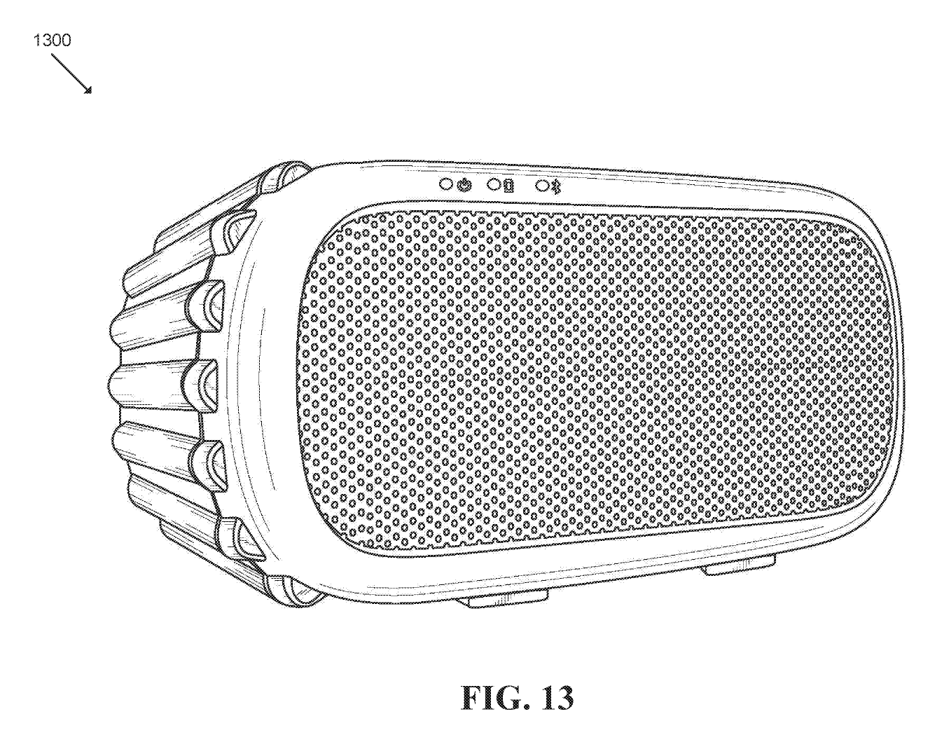

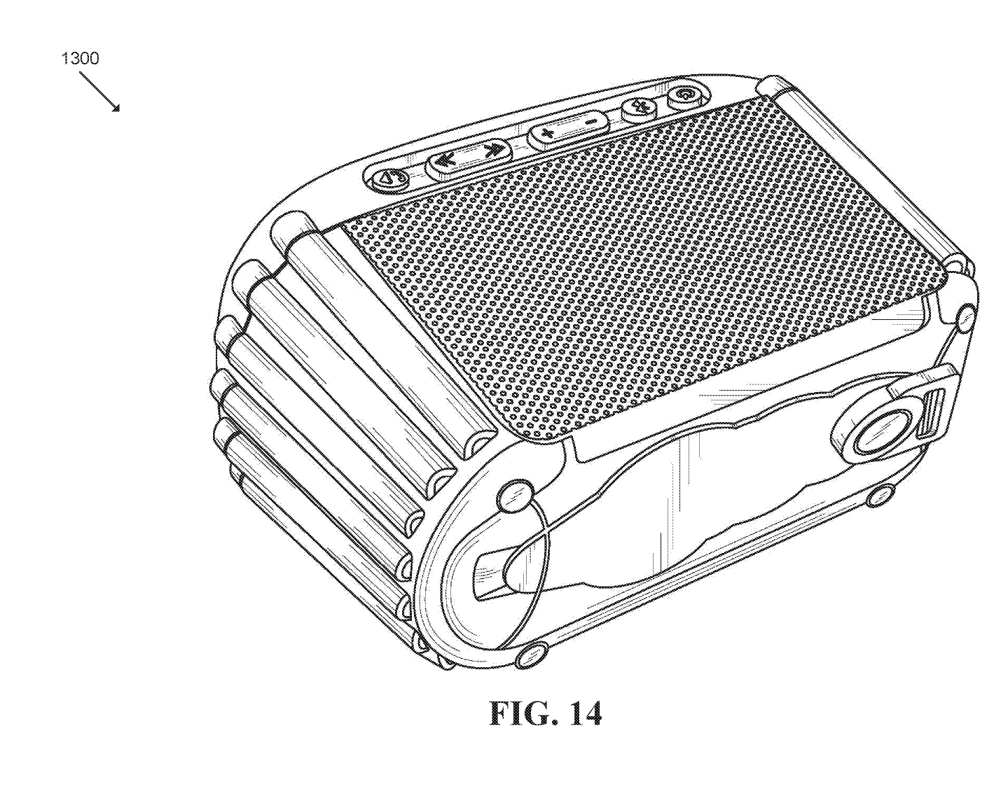

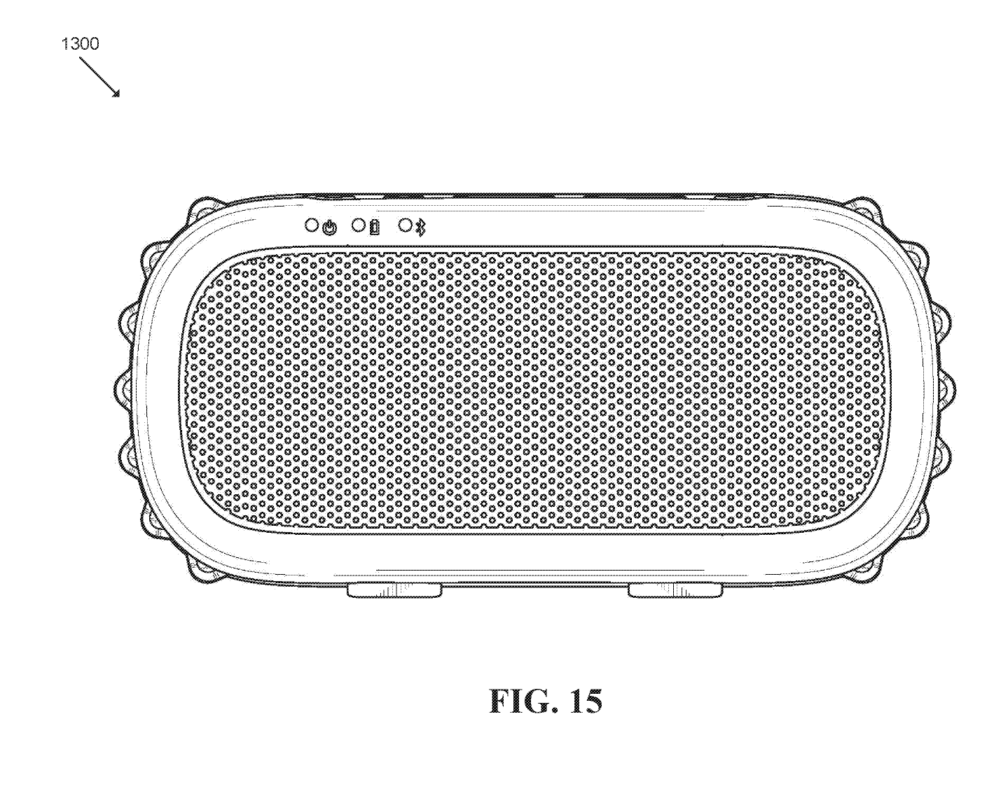

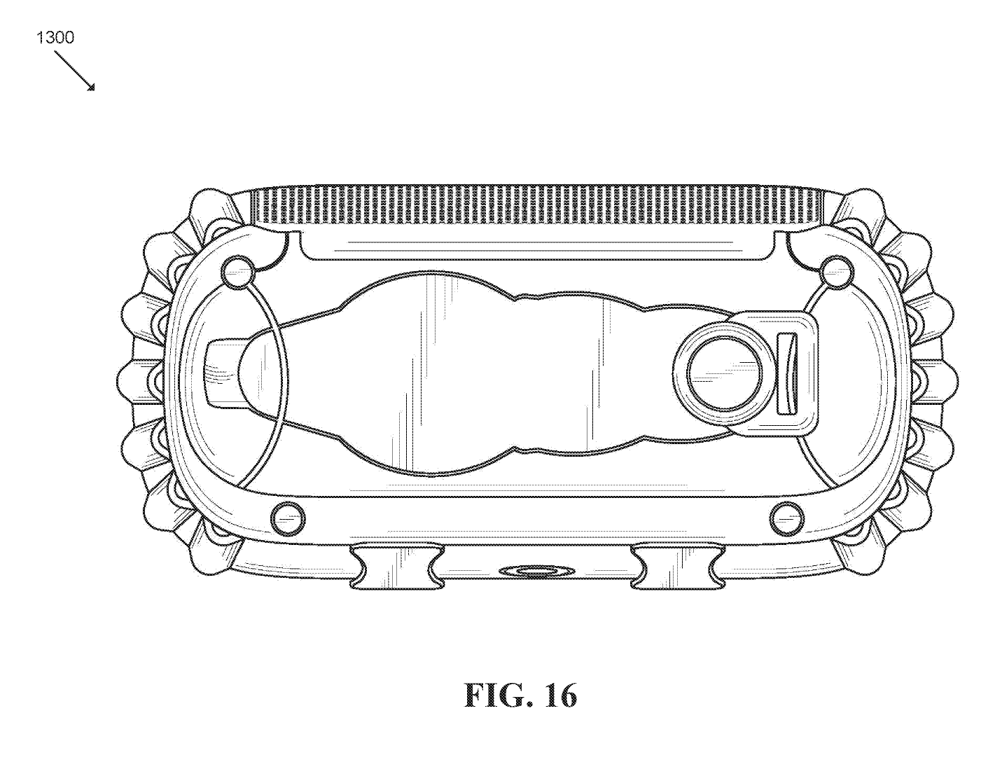

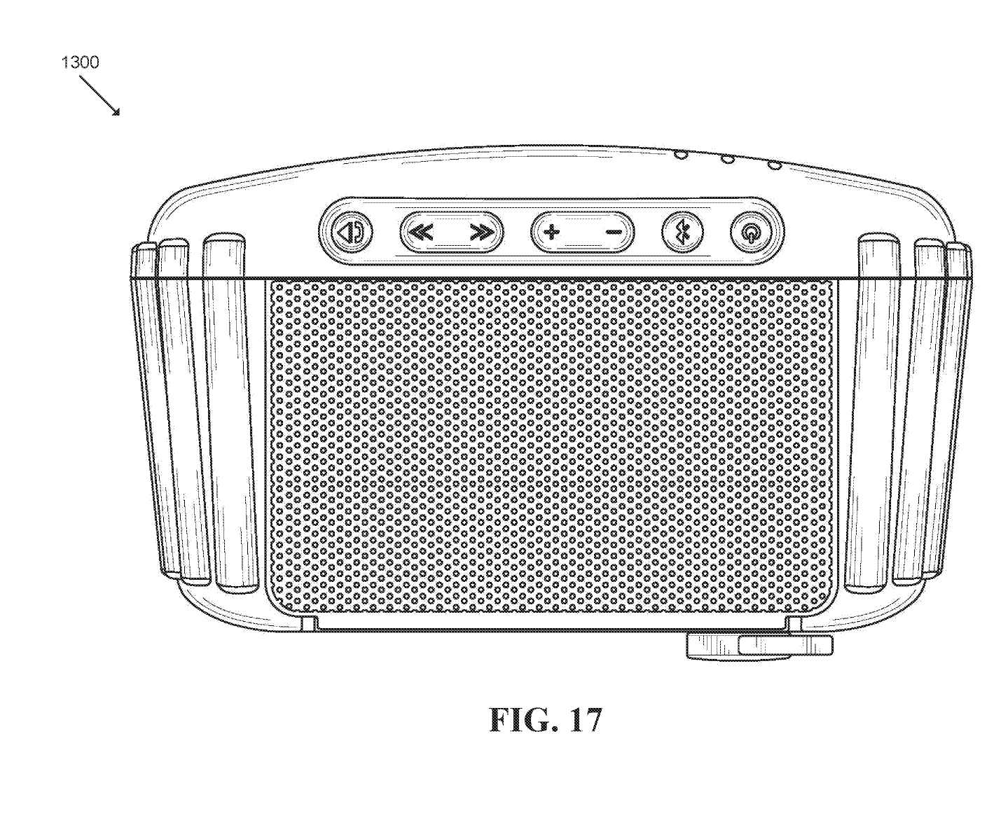

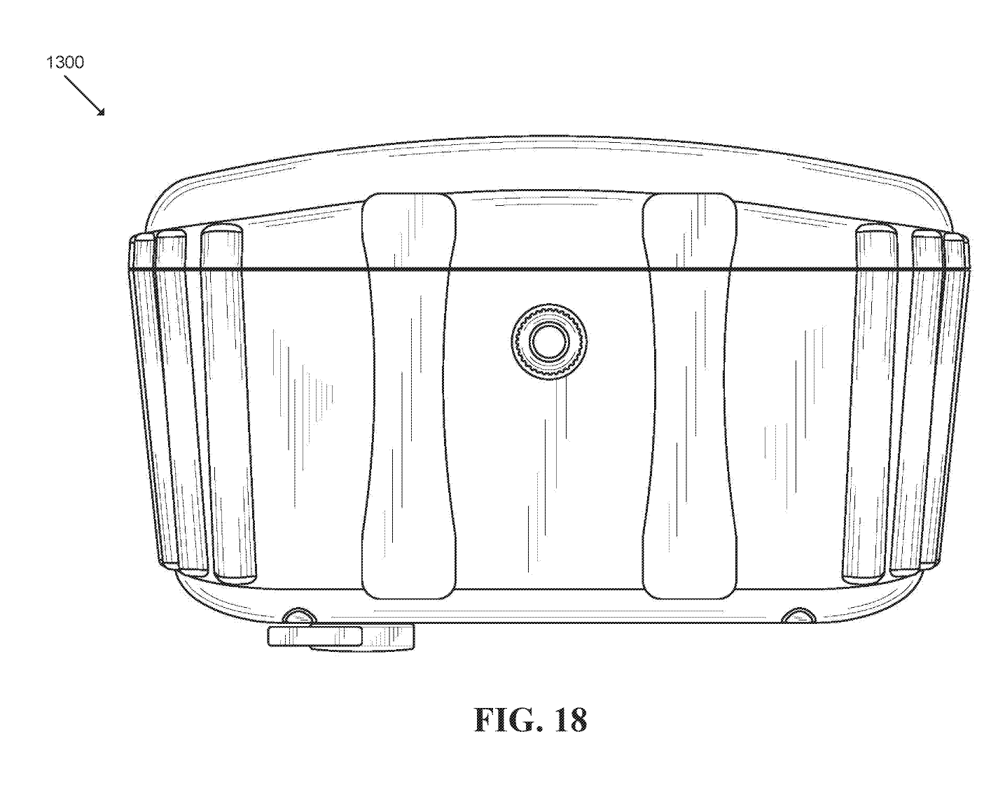

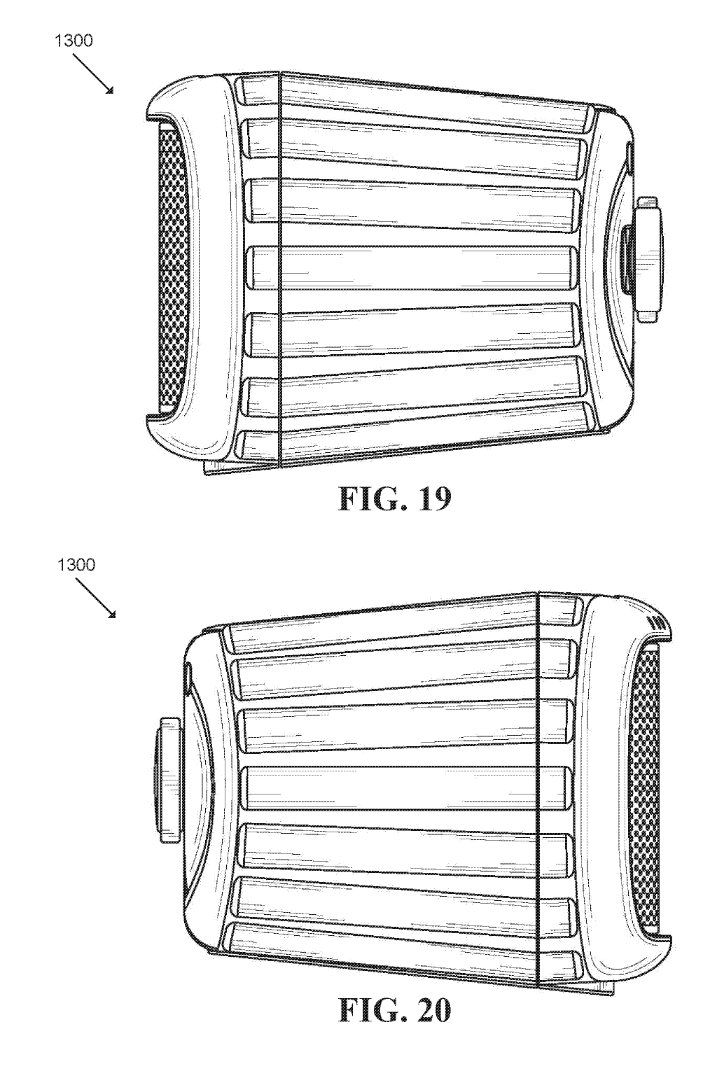

FIG. 13 illustrates a front-side perspective view of an exemplary portable speaker system 1300 of some embodiments. FIG. 14 illustrates a top-rear perspective view of the portable speaker system 1300. FIG. 15 illustrates a front elevation view of the portable speaker system 1300. FIG. 16 illustrates a rear side elevation view of the portable speaker system 1300. FIG. 17 illustrates a top plan view of the portable speaker system 1300. FIG. 18 illustrates a bottom plan view of the portable speaker system 1300. FIG. 19 illustrates a right elevation view of the portable speaker system 1300. FIG. 20 illustrates a left elevation view of the portable speaker system 1300.

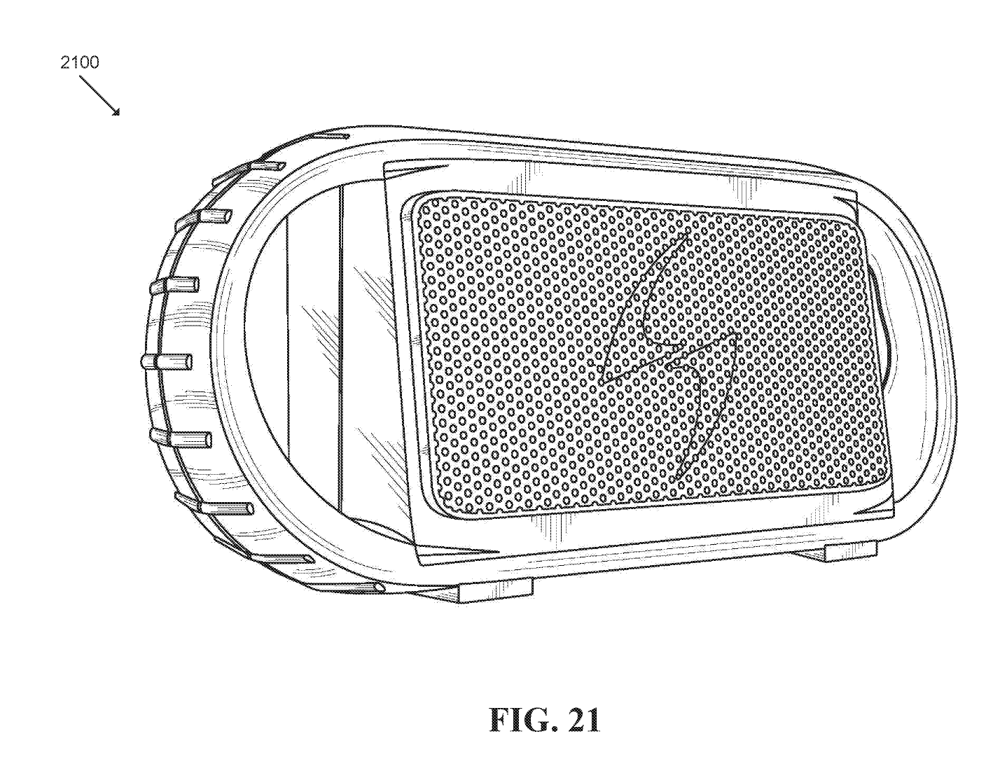

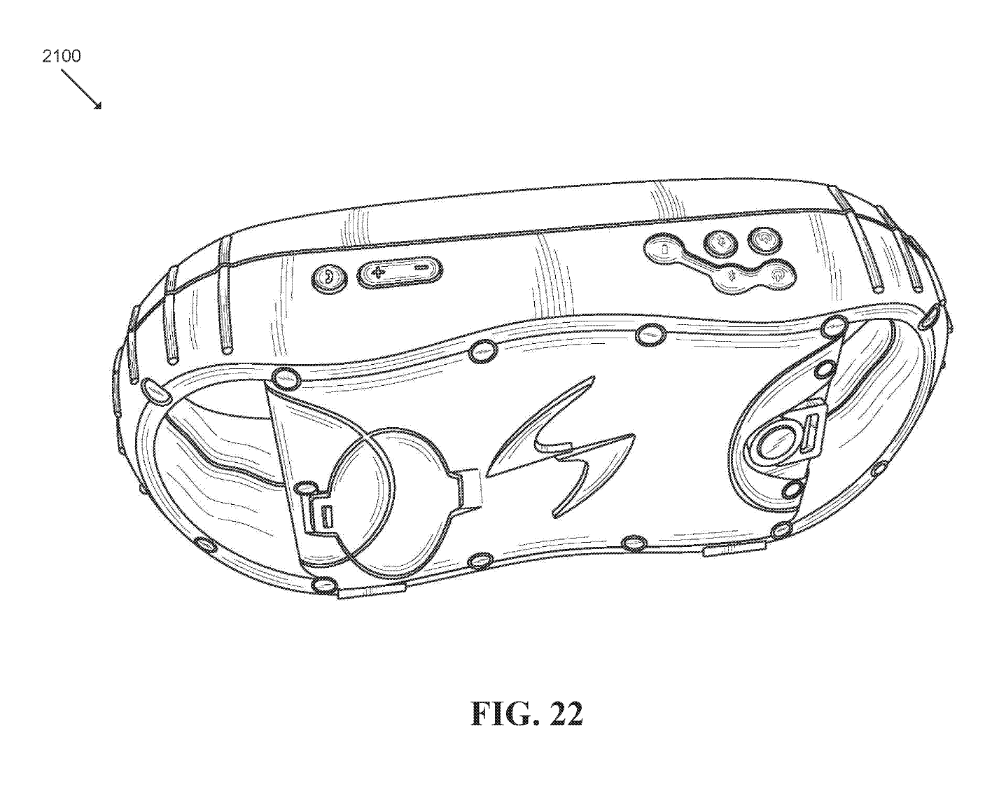

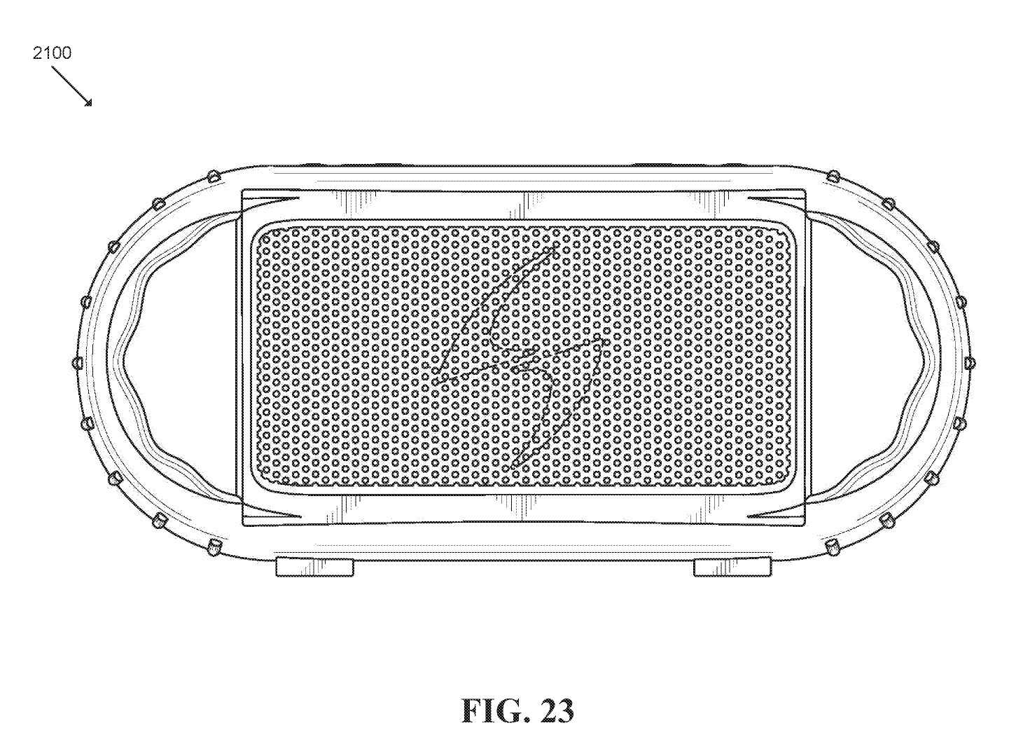

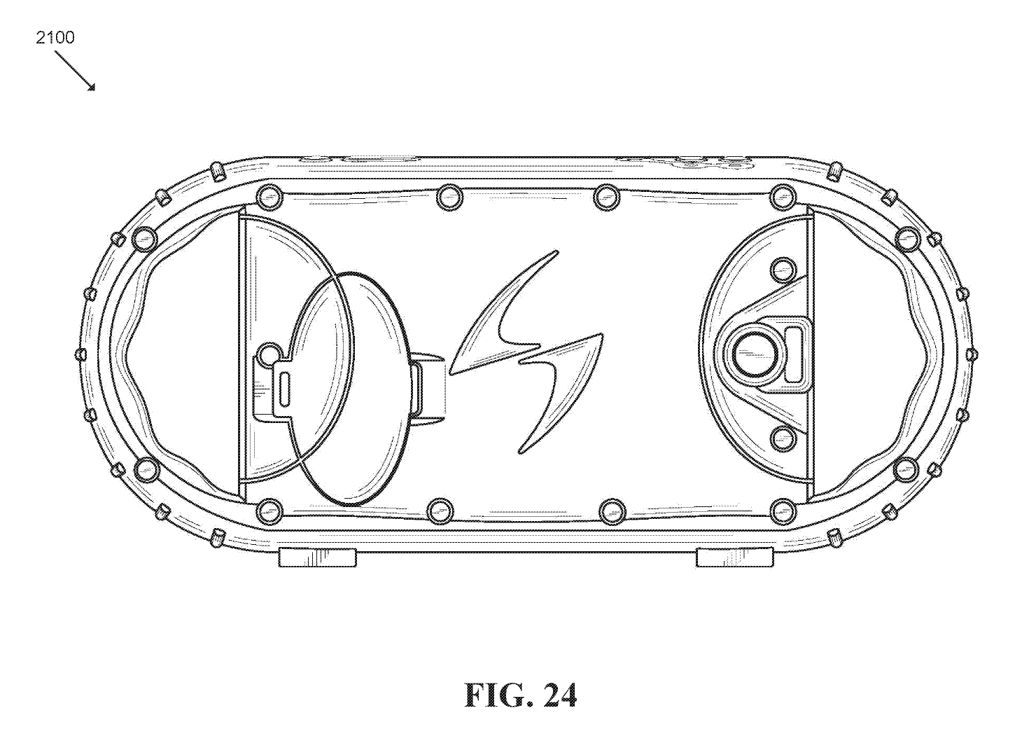

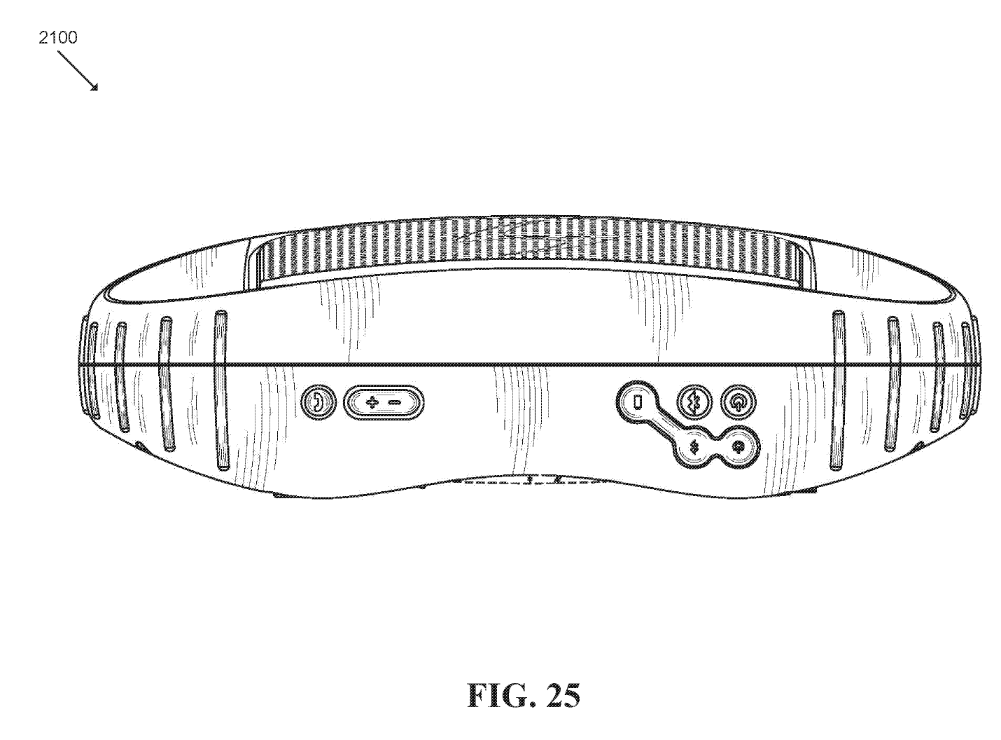

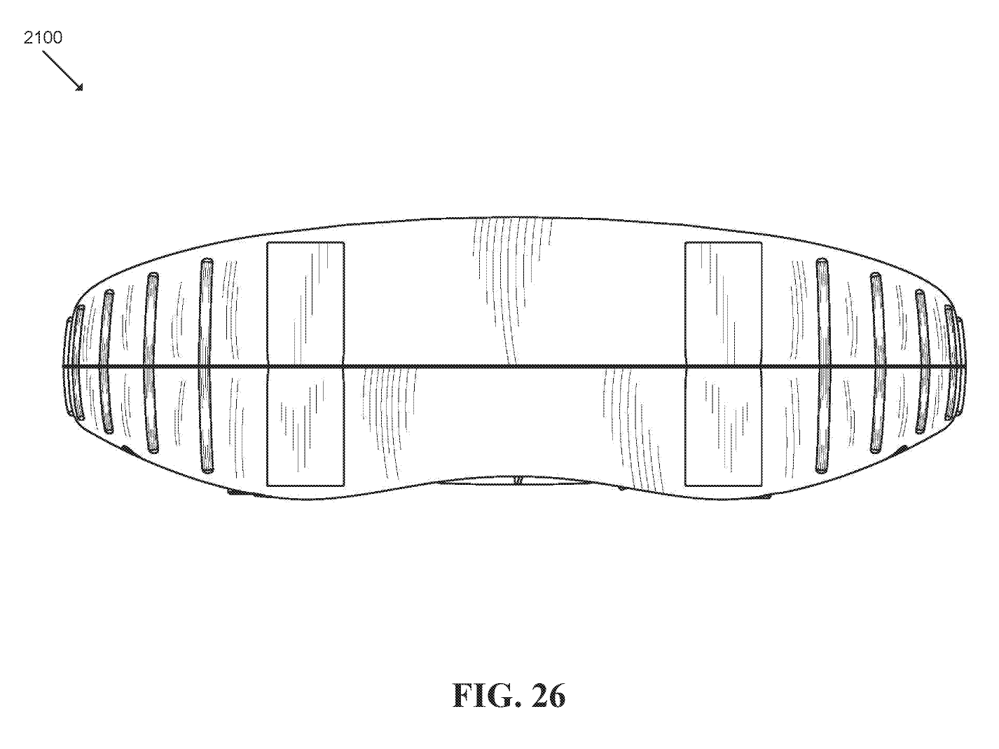

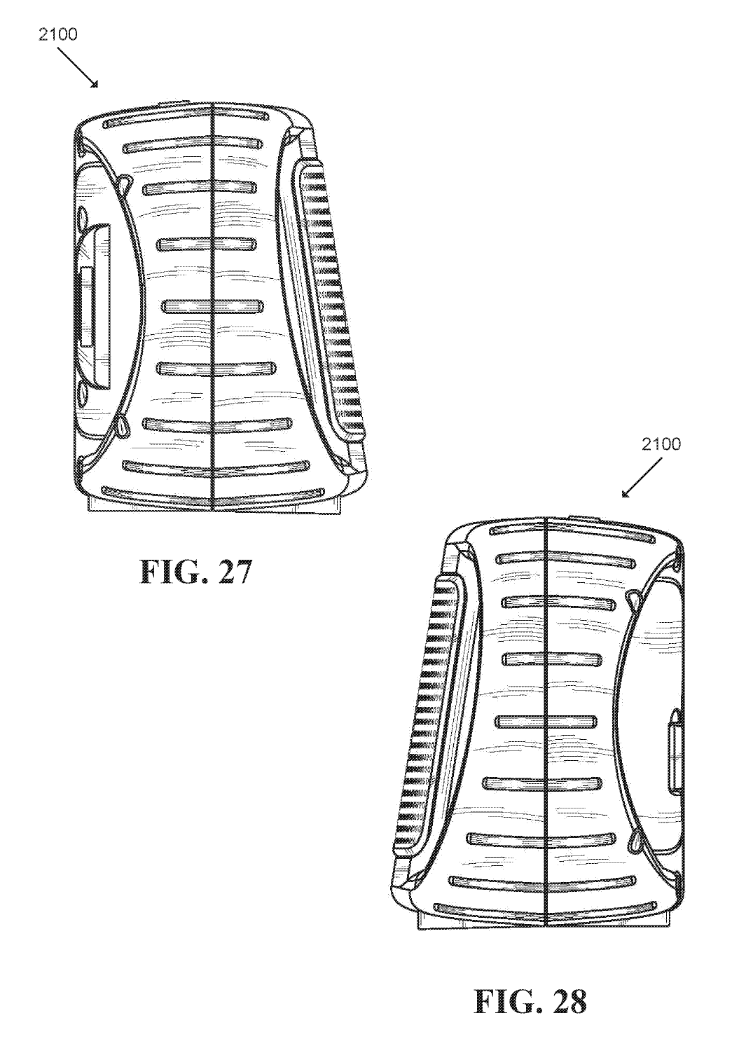

FIG. 21 illustrates a front-side perspective view of an exemplary portable speaker system 2100 of some embodiments. FIG. 22 illustrates a top-rear perspective view of the portable speaker system 2100. FIG. 23 illustrates a front elevation view of the portable speaker system 2100. FIG. 24 illustrates a rear side elevation view of the portable speaker system 2100. FIG. 25 illustrates a top plan view of the portable speaker system 2100. FIG. 26 illustrates a bottom plan view of the portable speaker system 2100. FIG. 27 illustrates a right elevation view of the portable speaker system 2100. FIG. 28 illustrates a left elevation view of the portable speaker system 2100.

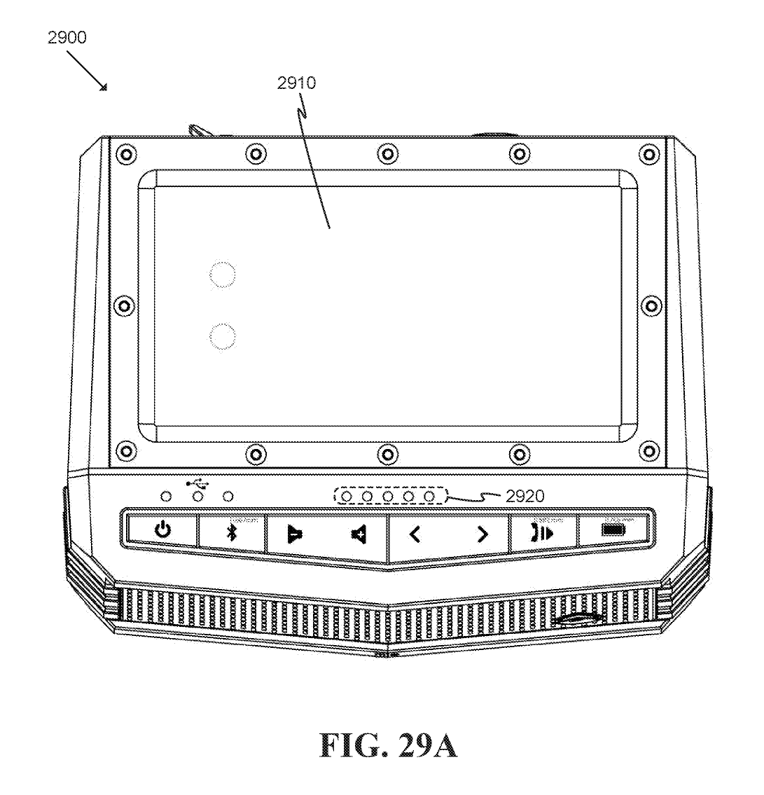

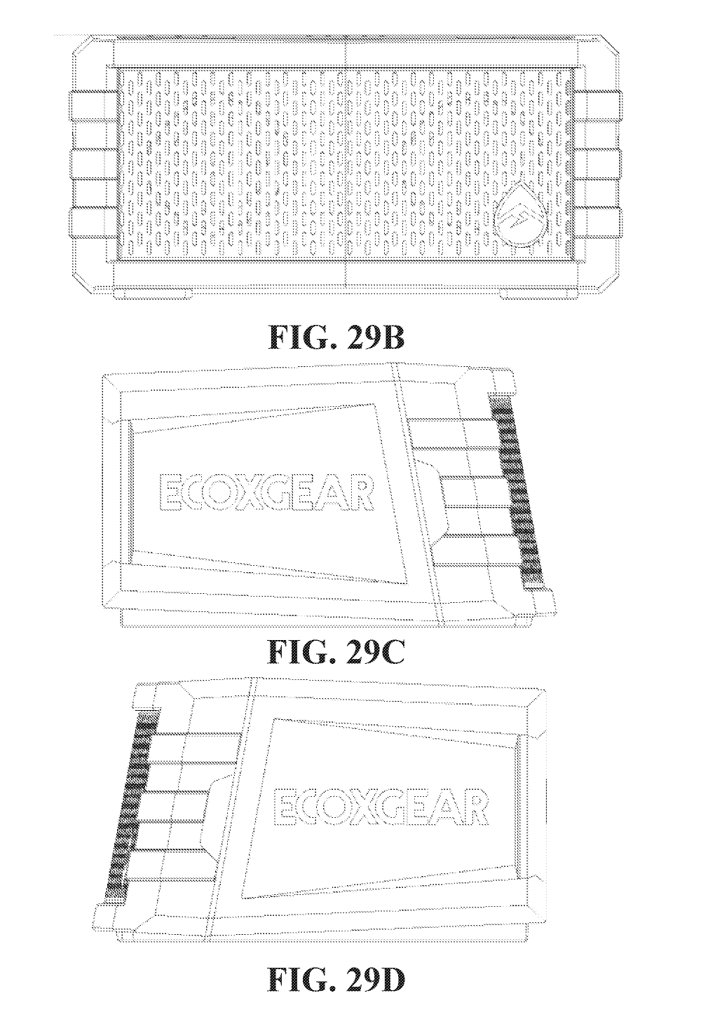

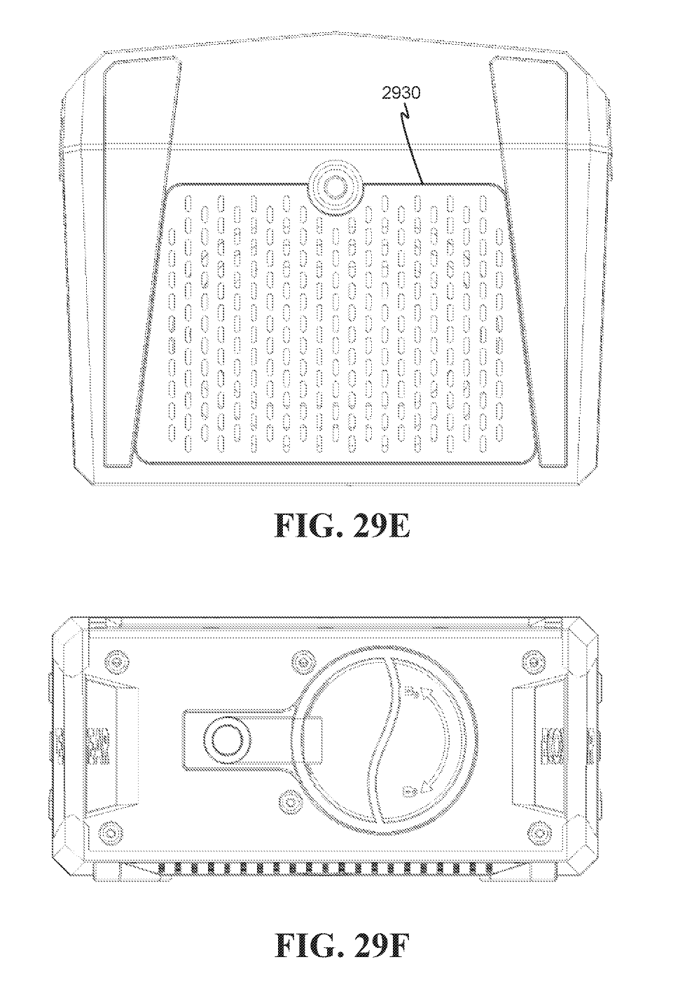

FIG. 29A illustrates a top plan view of an exemplary portable speaker system 2900 of some embodiments. FIGS. 29B-29F illustrate various views of the portable speaker system 2900. As shown, the system 2900 may include a solar cell 2910, associated UI element 2920, and a subwoofer (or other speaker) output 2930. In this example, the solar cell 2910 is on the top face of the device 2900. Output port 2930 is located on the bottom face.

The UI element 2920 may include a number of LEDs arranged in a linear array. The LEDs may indicate the strength of the solar energy 2910 and associated UI elements 2920. In this example, the solar cell is on the top face of the device 2900. The UI element 2920 may include a number of LEDs arranged in a linear array. The LEDs may indicate the strength of the solar energy received at cell 2910. For instance, the number of illuminated LEDs may indicate the relative energy strength one a scale of one to five, with one illuminated LED indicating a low level of received energy and five illuminated LEDs indicating a high level of received energy. The UI element 2920 may provide feedback to a user such that the device 2900 may be positioned to receive a maximum amount of energy.

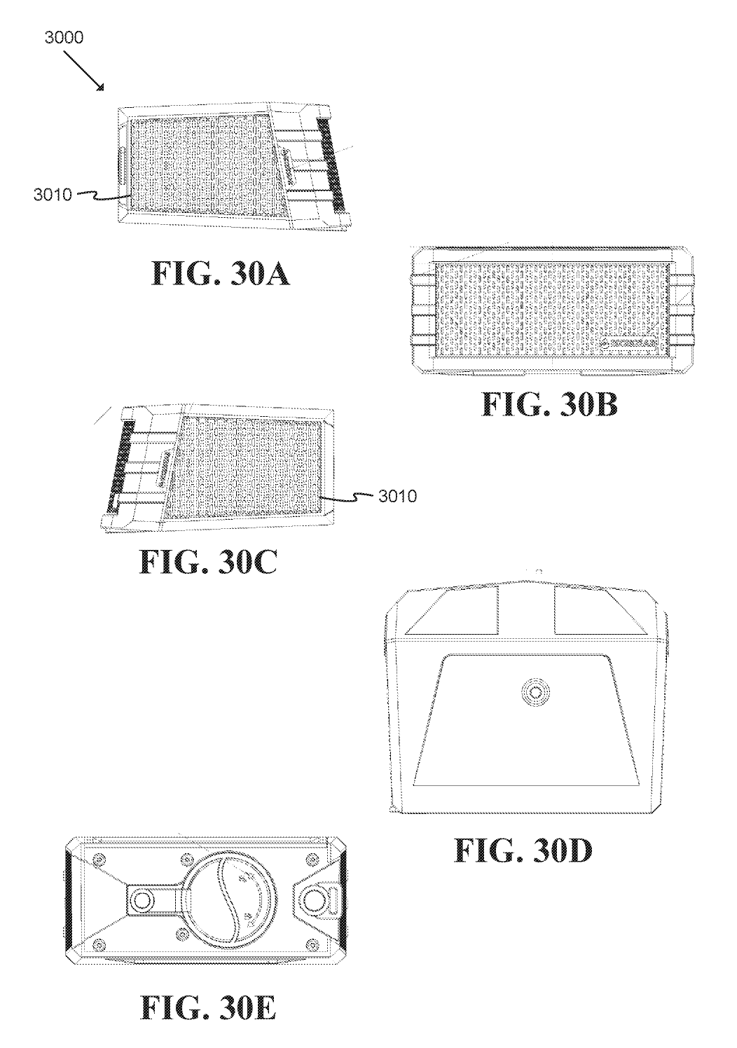

FIGS. 30A-30E illustrate various views of an exemplary portable speaker system 3000 of some embodiments. Such a system may have a top face similar to that of system 2900. As shown, system 3000 may include subwoofer (or other speaker or output types such as surround sound outputs, stereo outputs, etc.) outputs 3010 on each side. In this example the output ports are on the side of the enclosure.

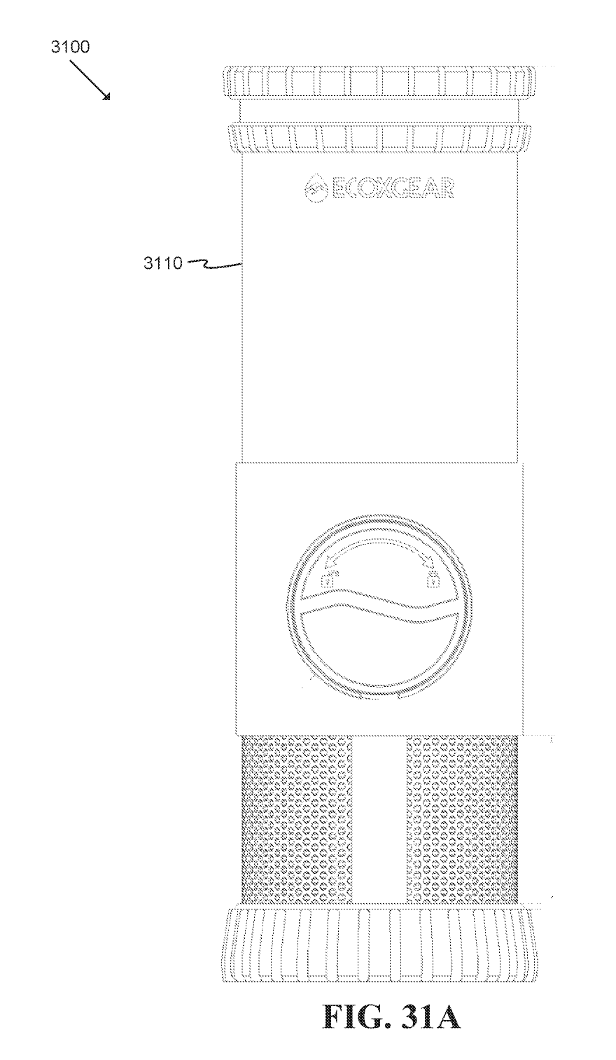

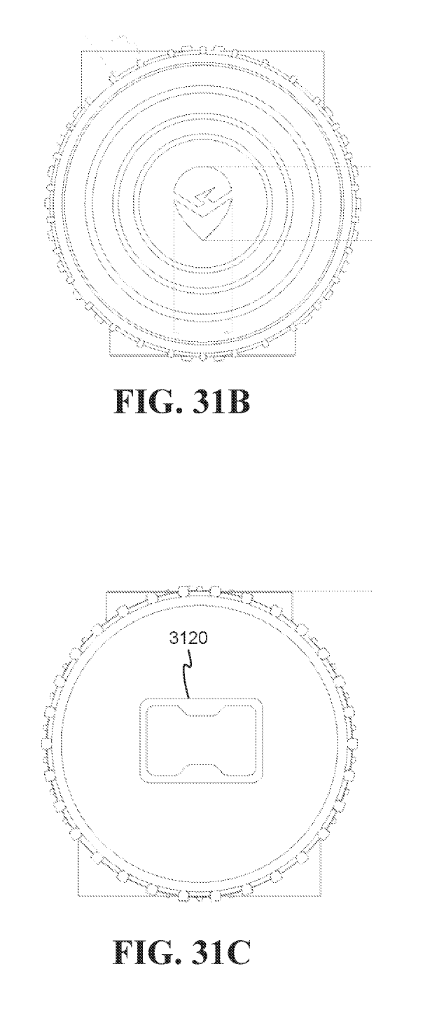

FIG. 31A illustrates a front elevation view of an exemplary portable speaker system 3100 of some embodiments. As shown, this example includes a lantern 3110. Such a lantern may include, for instance, a set of LEDs, various lenses and/or reflective elements, and one or more side panels. In this example, there is a single cylindrical side panel. The side panels may be made of transparent or semi-transparent material such that light may pass and/or be diffused.

FIGS. 31B-31C illustrate top and bottom plan views of the portable speaker system 3100. In this example, the system 3100 may include a bottle opener 3120 on the bottom face of the system 3100. Alternatively, the bottle opener 3120 may be located at other places on the exterior of the lantern 3100 (e.g., the top face, the side walls, etc.).

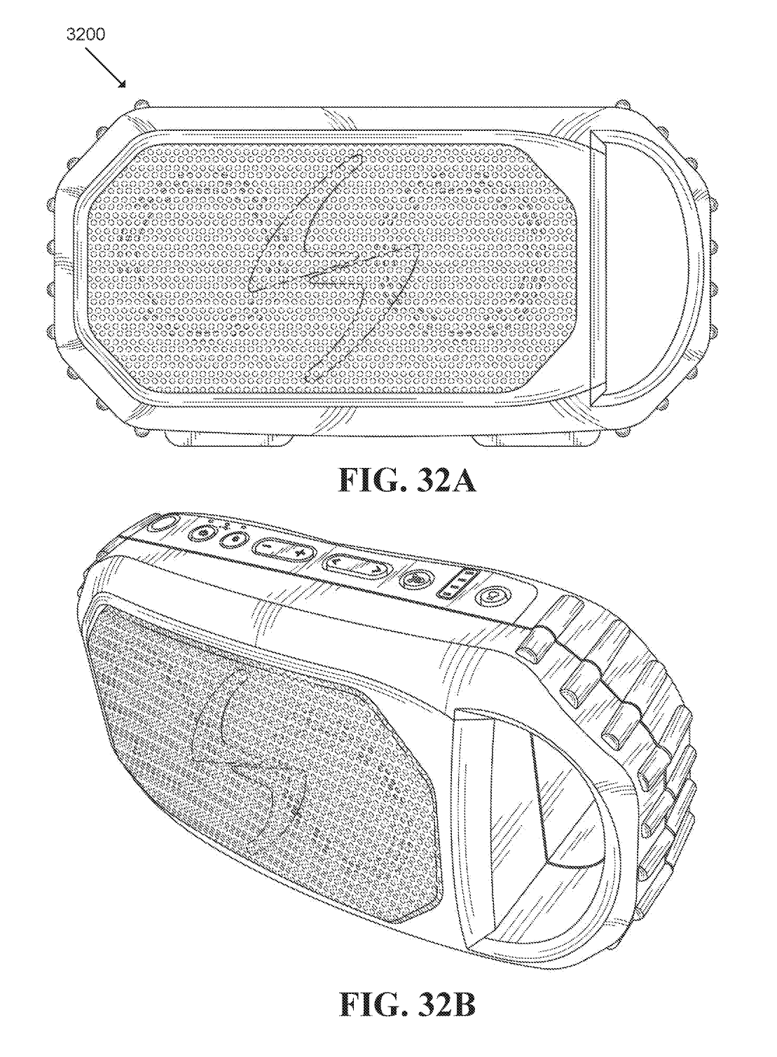

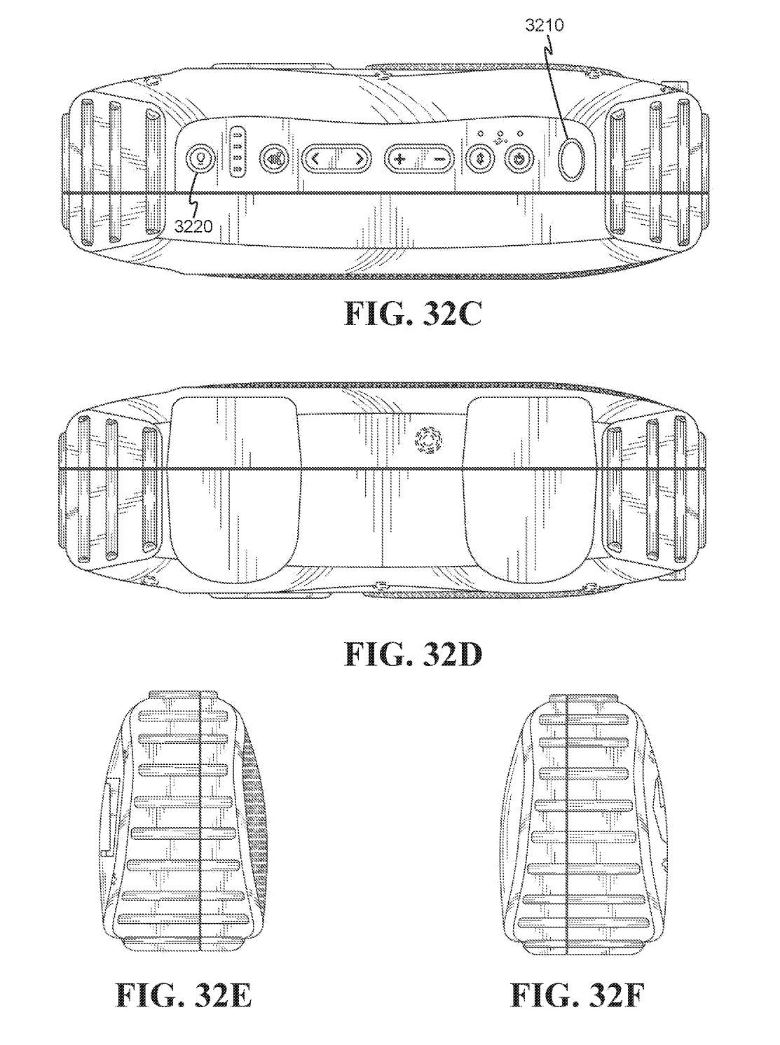

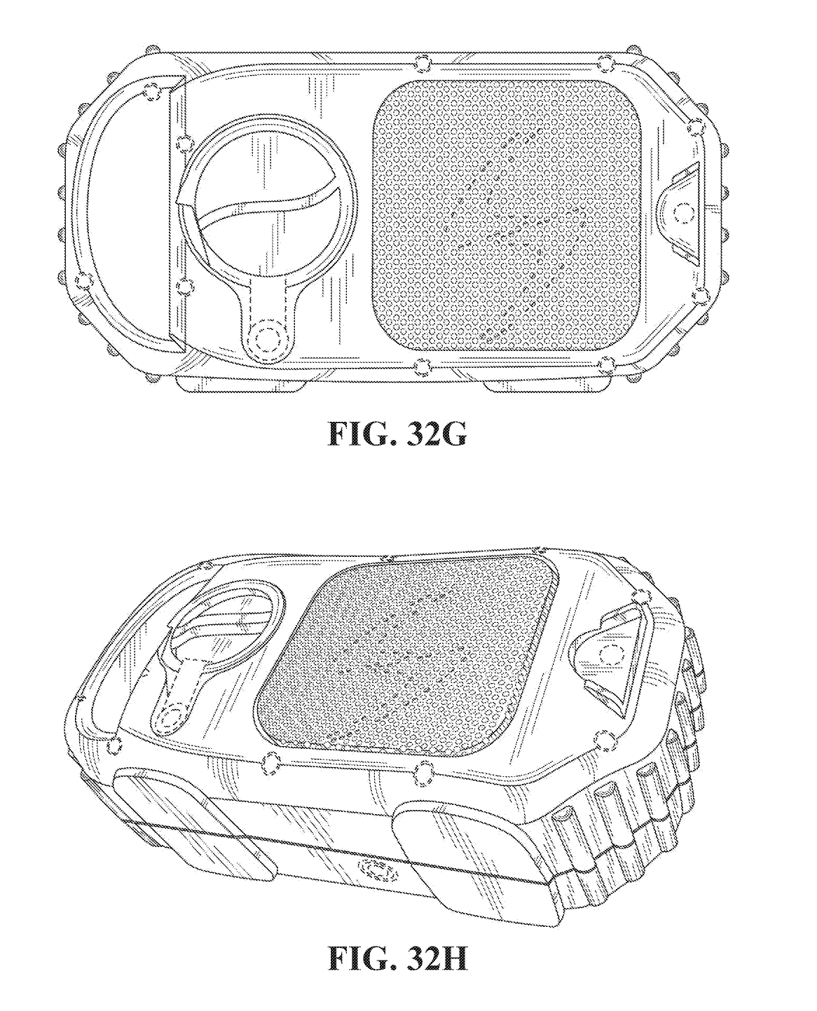

FIGS. 32A-32H illustrate various views of an exemplary portable speaker system 3200 of some embodiments. This example includes a flashlight output 3210 and associated on/off control 3220. Different embodiments may place the flashlight output 3210 at various different locations along the exterior of the speaker system 3200. Different embodiments may include various different controls 3220 (e.g., on/off, brightness, mode, etc.).

As shown, the exemplary portable speaker systems 1300, 2100, 2900, 3000, 3100, and 3200 may include various features described above in reference to FIGS. 1, 4A-4B, 5A-5B, 6A-6B, 7A-7B, and 8. In addition, the exemplary systems 1300, 2100, 2900, 3000, 3100, and 3200 may be able to perform the operations described above in reference to FIGS. 10-12.

One of ordinary skill in the art will recognize that the exemplary systems 1300, 2100, 2900, 3000, 3100, and 3200 may be implemented in various different ways without departing from the scope of the disclosure. For instance, different embodiments may include housings with different shapes, sizes, external features, etc. As another example, different embodiments may include various different UI elements than those shown. In addition, various features and/or combinations of features from each example system (or multiple example systems) may be included in other exemplary implementations. For instance, another exemplary embodiment may include a solar cell, a flashlight, and a lantern.

### V. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

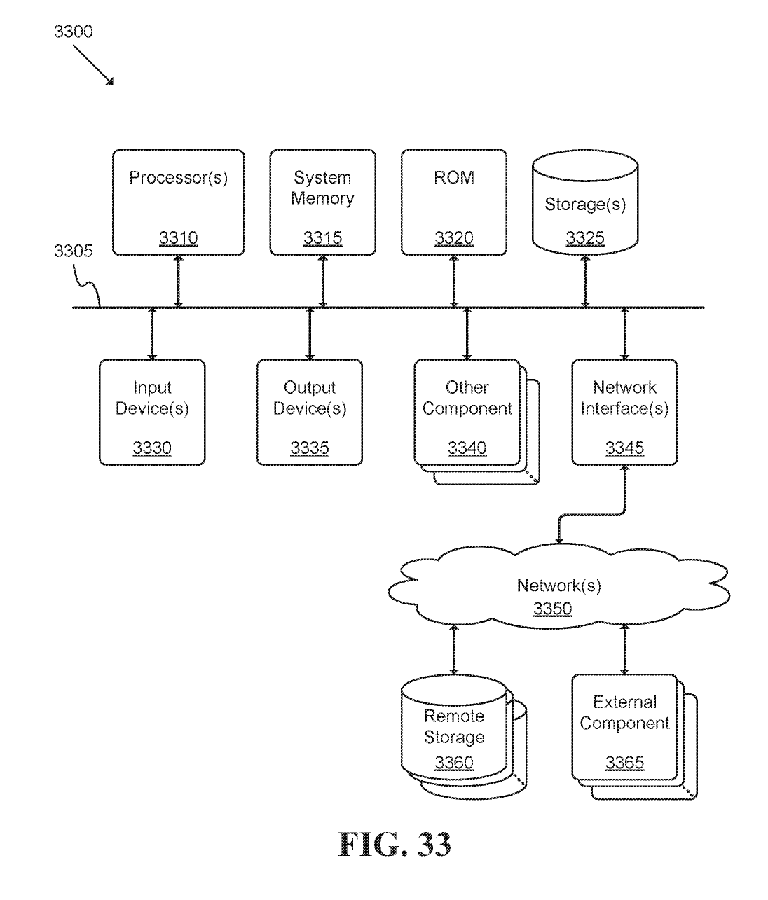

FIG. 33 illustrates a schematic block diagram of an exemplary computer system 3300 used to implement some embodiments. For example, the system described above in reference to FIGS. 2-3 may be at least partially implemented using computer system 3300. As another example, the processes described in reference to FIGS. 9-12 may be at least partially implemented using sets of instructions that are executed using computer system 3300.

Computer system 3300 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 3300 may include at least one communication bus 3305, one or more processors 3310, a system memory 3315, a read-only memory (ROM) 3320, permanent storage devices 3325, input devices 3330, output devices 3335, audio processors 3340, video processors 3345, various other components 3350, and one or more network interfaces 3355.

Bus 3305 represents all communication pathways among the elements of computer system 3300. Such pathways may include wired, wireless, optical, and/or other appropriate communication pathways. For example, input devices 3330 and/or output devices 3335 may be coupled to the system 3300 using a wireless connection protocol or system.

The processor 3310 may, in order to execute the processes of some embodiments, retrieve instructions to execute and/or data to process from components such as system memory 3315, ROM 3320, and permanent storage device 3325. Such instructions and data may be passed over bus 3305.

System memory 3315 may be a volatile read-and-write memory, such as a random access memory (RAM). The system memory may store some of the instructions and data that the processor uses at runtime. The sets of instructions and/or data used to implement some embodiments may be stored in the system memory 3315, the permanent storage device 3325, and/or the read-only memory 3320. ROM 3320 may store static data and instructions that may be used by processor 3310 and/or other elements of the computer system.

Permanent storage device 3325 may be a read-and-write memory device. The permanent storage device may be a non-volatile memory unit that stores instructions and data even when computer system 3300 is off or unpowered. Computer system 3300 may use a removable storage device and/or a remote storage device as the permanent storage device.

Input devices 3330 may enable a user to communicate information to the computer system and/or manipulate various operations of the system. The input devices may include keyboards, cursor control devices, audio input devices and/or video input devices. Output devices 3335 may include printers, displays, audio devices, etc. Some or all of the input and/or output devices may be wirelessly or optically connected to the computer system 3300.

Audio processor 3340 may process and/or generate audio data and/or instructions. The audio processor may be able to receive audio data from an input device 3330 such as a microphone. The audio processor 3340 may be able to provide audio data to output devices 3340 such as a set of speakers. The audio data may include digital information and/or analog signals. The audio processor 3340 may be able to analyze and/or otherwise evaluate audio data (e.g., by determining qualities such as signal to noise ratio, dynamic range, etc.). In addition, the audio processor may perform various audio processing functions (e.g., equalization, compression, etc.).

The video processor 3345 (or graphics processing unit) may process and/or generate video data and/or instructions. The video processor may be able to receive video data from an input device 3330 such as a camera. The video processor 3345 may be able to provide video data to an output device 3340 such as a display. The video data may include digital information and/or analog signals. The video processor 3345 may be able to analyze and/or otherwise evaluate video data (e.g., by determining qualities such as resolution, frame rate, etc.). In addition, the video processor may perform various video processing functions (e.g., contrast adjustment or normalization, color adjustment, etc.). Furthermore, the video processor may be able to render graphic elements and/or video.

Other components 3350 may perform various other functions including providing storage, interfacing with external systems or components, etc.

Finally, as shown in FIG. 33, computer system 3300 may include one or more network interfaces 3355 that are able to connect to one or more networks 3360. For example, computer system 3300 may be coupled to a web server on the Internet such that a web browser executing on computer system 3300 may interact with the web server as a user interacts with an interface that operates in the web browser. Computer system 3300 may be able to access one or more remote storages 3370 and one or more external components 3375 through the network interface 3355 and network 3360. The network interface(s) 3355 may include one or more application programming interfaces (APIs) that may allow the computer system 3300 to access remote systems and/or storages and also may allow remote systems and/or storages to access computer system 3300 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 3300 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

We claim:

1. A portable speaker system comprising:
a waterproof enclosure;
a wireless communication element;
a set of speakers; and
a solar cell.

2. The portable speaker system of claim 1 further comprising a microphone.

3. The portable speaker system of claim 1, wherein the wireless communication element is able to be connected to a mobile device and receive multimedia data from the mobile device via the wireless communication element.

4. The portable speaker system of claim 1, wherein the waterproof enclosure comprises:
a first section;
a gasket coupled to a portion of the first section; and
a second section coupled to the gasket.

5. The portable speaker system of claim 1, wherein the waterproof enclosure comprises a set of user interface (UI) elements.

6. The portable speaker system of claim 5, wherein the UI elements comprise a set of buttons and a set of visual indicator elements.

7. The portable speaker system of claim 1, wherein the wireless communication element is able to establish a Bluetooth link with a mobile device.

8. A device that provides multimedia content, the device comprising:
a communication module able to be communicatively coupled to a mobile device via a communication link;
a processor able to receive multimedia data over the communication link;
a set of output elements able to generate user-sensible outputs based at least partly on the received multimedia data; and
an electromagnetic charging element.

9. The device of claim 8, wherein the multimedia data comprises audio data.

10. The device of claim 9, wherein the set of output elements comprises:
a plurality of active speakers; and
at least one passive woofer element.

11. The device of claim 8 further comprising a set of shock absorption features.

12. The device of claim 11, wherein the set of shock absorption features comprises:
a polycarbonate inner shell able to provide structural integrity for the device; and
a thermoplastic elastomer cover coupled to an external surface of the inner shell.

13. The device of claim 8, further comprising a waterproof enclosure able to house the device.

14. The device of claim 8 further comprising a microphone able to receive aural inputs and send data associated with the received inputs to the mobile device over the communication link.

15. A multimedia playback device comprising:
a waterproof enclosure;
a set of user interface (UI) features;
a set of audio output elements;
a set of audio input elements;
at least one connection port;
a wireless communication element;
a rechargeable battery; and
a light emitting diode (LED) flashlight output.

16. The multimedia playback device of claim 15, wherein the set of audio output elements includes a plurality of speakers and the set of audio input elements includes at least one microphone.

17. The multimedia playback device 15, wherein the at least one connection port comprises a universal serial bus (USB) connection.

18. The multimedia playback device 15, wherein the set of UI features comprises:
a device activation element;
a wireless communication activation element;
a volume control element;
a playback control element; and
a speakerphone activation element.

19. The multimedia playback device 15 further comprising a mounting feature able to allow the multimedia playback device to be coupled to an external support element.

20. The multimedia playback device 15, wherein the waterproof enclosure is able to be able to float on a body of water.
